(19) United States
(12) Patent Application Publication
(10) Pub. No.: US 2026/0048317 A1
(43) Pub. Date: Feb. 19, 2026

(54) Systems and Methods for Portable Digital Scoreboards with LED Displays and Wireless Control

(71) Applicant: Jeffrey Todd Brown, Clarksburg, MD (US)

(72) Inventor: Jeffrey Todd Brown, Clarksburg, MD (US)

(21) Appl. No.: 19/303,353

(22) Filed: Aug. 19, 2025

(51) Int. Cl. A63B 71/06; G01M 3/26; G06F 3/14

(52) U.S. Cl. CPC A63B 71/0669; G01M 3/26; G06F 3/1446

(57) ABSTRACT

A device may determine a layout of the reconfigurable modular display. A device may establish local wireless connectivity to accept concurrent connections from client devices without reliance on external networking infrastructure. A device may obtain game-state data from at least one external source via a programmatic interface. A device may render scoreboard graphics according to the layout. A device may present an interactive activity on the reconfigurable modular display and receive spectator inputs via the local wireless connectivity. A device may update the reconfigurable modular display based at least on the game-state data and an aggregation of the spectator inputs.

### BACKGROUND OF THE INVENTION

### Technical Field

The present disclosure generally relates to electronic score display systems for athletic events and more particularly to portable, battery-powered scoreboard apparatus configured for field or gym deployment with wireless user interfaces.

### Description of the Related Art

Electronic scoreboards are known and have been implemented using LED or LCD displays to present scores, time, and game periods for a variety of sports. Portable units have been offered that operate from internal batteries and are mountable on tripods, fences, or walls. Conventional systems are commonly controlled by a handheld remote or a mobile application over short-range wireless links such as Bluetooth or Wi-Fi and may provide sport selection presets for basic scoring and timing functions. Modular display panels used in digital signage, event message boards, and fitness timers are also known, as are weather-resistant housings adapted for outdoor use.

### SUMMARY OF THE INVENTION

In some aspects, the techniques described herein relate to a non-transitory machine-readable storage medium including instructions that, when executed by one or more processors of a portable scoreboard controller operatively coupled to a reconfigurable modular display including a plurality of display tiles interconnected by a power and data interconnect, cause the controller to: determine a layout of the reconfigurable modular display; establish local wireless connectivity to accept concurrent connections from client devices without reliance on external networking infrastructure; obtain game-state data from at least one external source via a programmatic interface; render scoreboard graphics according to the layout; present an interactive activity on the reconfigurable modular display and receive spectator inputs via the local wireless connectivity; and update the reconfigurable modular display based at least on the game-state data and an aggregation of the spectator inputs.

In some aspects, the techniques described herein relate to a method of manufacturing a portable interactive scoreboard assembly including: extruding or procuring an elongated rail that defines an internal conduit; installing within the internal conduit a power and data interconnect terminated by polarized waterproof multi-pin connectors; affixing the elongated rail to or within an enclosure; mechanically attaching a plurality of display tiles to the elongated rail and mating the display tiles to the polarized waterproof multi-pin connectors to form a reconfigurable modular display; and installing a controller and a power-management circuit within the enclosure and electrically coupling the controller to the power and data interconnect.

In some aspects, the techniques described herein relate to a portable interactive scoreboard system including: a reconfigurable modular display including a plurality of display tiles mechanically attachable to a backplane providing a power and data interconnect; a controller operatively coupled to the reconfigurable modular display and configured to drive scoreboard graphics on the display tiles via the power and data interconnect; and an interaction engine of the controller configured to present an interactive activity on the reconfigurable modular display and to receive spectator inputs via a local wireless connectivity provided by the controller; wherein the controller updates the reconfigurable modular display based at least on game-state data received via a programmatic interface and an aggregation of the spectator inputs. The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

Aspects described below include a non-transitory computer-readable storage medium comprising computer-executable instructions that, responsive to execution by a processor, cause a system to perform any one of the described methods.

Aspects described below also include a system with means for performing Systems and Methods for Portable Digital Scoreboards with LED Displays and Wireless Control.

### BRIEF DESCRIPTION OF THE FIGURES

The appended figures depict certain features of the various aspects described herein and are not to be considered limiting of the scope of this disclosure.

FIG. 1 depicts a block diagram of a data processing environment in which illustrative embodiments may be implemented.

FIG. 2 depicts a block diagram of a data processing system in which illustrative embodiments may be implemented.

Referring to FIG. 3, which illustrates a system core architecture for a portable, wireless-controlled LED scoreboard, a portable scoreboard controller may coordinate networking, external data ingestion, layout computation, rendering, interactivity, and power-aware behaviors to drive a reconfigurable modular display formed from display tiles interconnected by a power and data interconnect.

Referring to FIG. 4, a reconfigurable modular display may be formed as an aggregate display assembly in which multiple display tiles may be mechanically and electrically coupled to a backplane through a power and data interconnect so that the physical size and logical layout of the display may change by adding or removing tiles.

Referring to FIG. 5, a dual-sided configuration may be realized as a back-to-back assembly in which two reconfigurable modular displays are mounted on opposite faces of a common enclosure spine so that content may be presented toward two viewing directions while sharing controller, power, and mechanical infrastructure.

According to an example, processor is processor of FIG. 6.

Referring to FIG. 7, a scene configuration interface may provide a declarative layout editor through which an operator or designer may define visual arrangements, styles, and behaviors without modifying low-level rendering code.

Referring to FIG. 8, which illustrates networking and interactivity for a portable scoreboard controller, a locally hosted network may be provided by local wireless connectivity that is served by a local wireless connectivity interface resident within the controller hardware.

Referring to FIG. 9, which illustrates a power system and battery-management architecture for a portable scoreboard controller, a power-path circuitry may route energy among external inputs, a removable rechargeable battery, and regulated loads for the display tiles and logic subsystems.

Referring to FIG. 11, which illustrates a controller software stack and data-flow architecture for a portable scoreboard system, a controller core may host cooperating services that collectively provide local wireless connectivity, programmatic ingestion, interactive participation, rendering, and diagnostics.

FIG. 12 is a flowchart.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known structures, functions, methods, procedures, components, and/or circuitry have been described at a relatively high level, without detail, to avoid unnecessarily obscuring aspects of the present teachings.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to. ” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

Systems and techniques described herein may be used to overcome the limitations of traditional methods for presenting time-varying event information in outdoor or temporary venues. Conventional scoreboards and portable displays often depend on fixed infrastructure, wired networking, or specialized remotes, which may not be available at community fields or pop-up events. Manual approaches such as whiteboards or flip cards can be error-prone and may lack visibility at a distance, especially under bright ambient light.

Existing solutions may constrain who can operate the display, may not support concurrent input from multiple devices, and may not reconcile information coming from different sources. In many cases, field setups require lengthy configuration steps, repeated pairing procedures, or reliance on venue connectivity, which can introduce latency and service interruptions. Rigid or single-size displays can complicate deployment across different spaces, and lack of weather resilience may limit use in variable outdoor environments.

To address these issues, the present disclosure provides systems and methods that may include a portable controller coupled to a reconfigurable modular display formed from multiple display tiles interconnected by a power and data interconnect. The controller may establish local wireless connectivity that permits client devices to join without external infrastructure, and may execute instructions that determine a layout of the modular display, map rendered graphics to that layout, and update content accordingly. The controller may obtain game-state or other event data via a programmatic interface from external services and may reconcile such data with operator inputs.

In some examples, the controller may present an interactive activity on the modular display and accept spectator inputs through the local wireless connectivity. The system may support optional dual-sided configurations, ambient-light-responsive brightness control, and power management suitable for battery operation, with optional photovoltaic charging. Enclosures and mounting options may enable deployment on fences, tripods, or walls, and diagnostic routines may verify provisioning, pairing, field enumeration, and latency characteristics at setup or manufacturing test.

An example technique may include executing instructions stored on a non-transitory machine-readable medium by a controller that is operatively coupled to a modular display formed from a plurality of tiles. The instructions may cause the controller to determine a current tile layout, establish local wireless connectivity for multiple client devices without reliance on external infrastructure, and obtain game-state data via a programmatic interface from an external source. The controller may render scoreboard graphics based on the determined layout and present an interactive activity on the modular display while receiving spectator inputs through the local wireless connectivity. The controller may update the modular display using a combination of the programmatically obtained game-state data and aggregated spectator inputs.

Consider a pop-up community disaster-relief center operating in a public park after a severe storm. Organizers may transport a compact display assembly and mount it on a fence at the site entrance. When powered, the controller may create a local wireless connectivity point that visitors and volunteers may join by scanning a pairing code shown on the display. The controller may determine the arrangement of the display tiles, select a layout, and begin rendering information such as time slots for supply pickup and shelter capacity updates. A programmatic interface may ingest external data from a municipal feed, for example updated weather advisories or road closures, to keep information current without manual reentry.

Volunteers with role-based access may use their phones to adjust site-specific fields, such as current queue length or next distribution window, while visitors may participate in an interactive activity to indicate needs (e.g., baby supplies, pet food, charging stations). The controller may aggregate these spectator inputs and update the display with the most requested items so that logistics staff can prioritize restocking. The system may maintain responsiveness in low-connectivity conditions by relying on the local wireless connectivity for control and by caching updates. If the site becomes crowded, the display may switch to a high-contrast scene that remains readable in bright conditions, and the controller may coordinate refresh across dual-sided panels to serve people approaching from either direction. At closing time, a diagnostic routine may verify that pairing, tile enumeration, and latency remained within expected bounds, and logs may be saved for after-action review by the relief organization.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

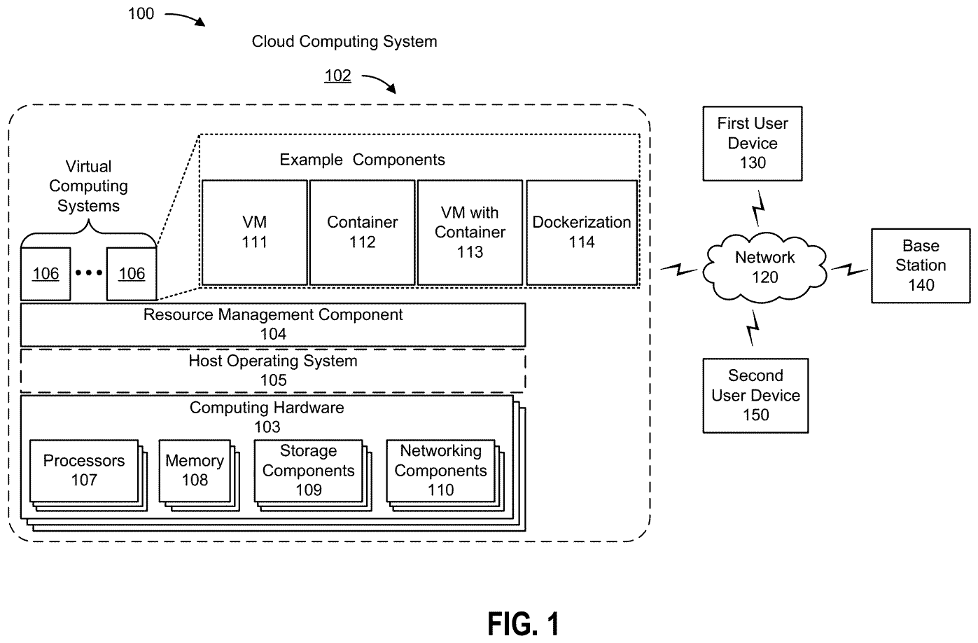

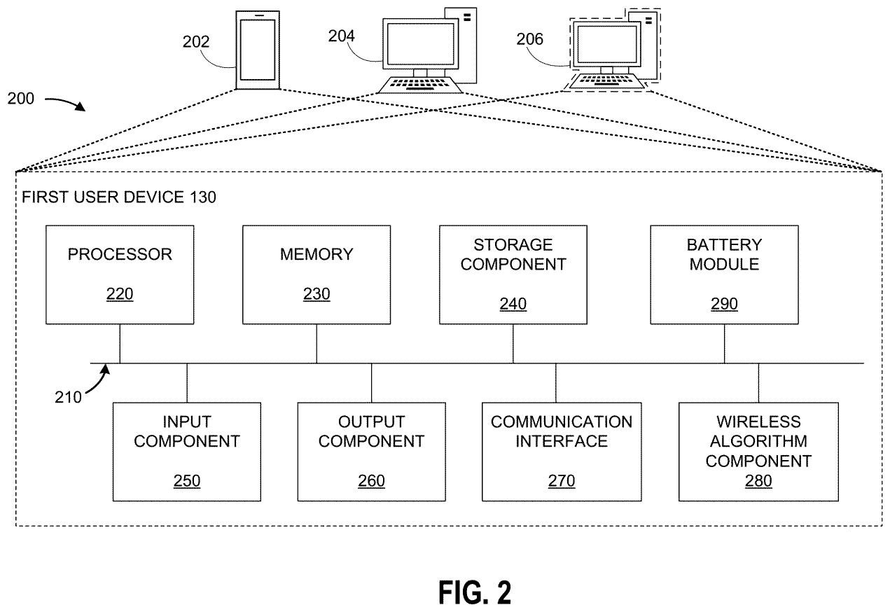

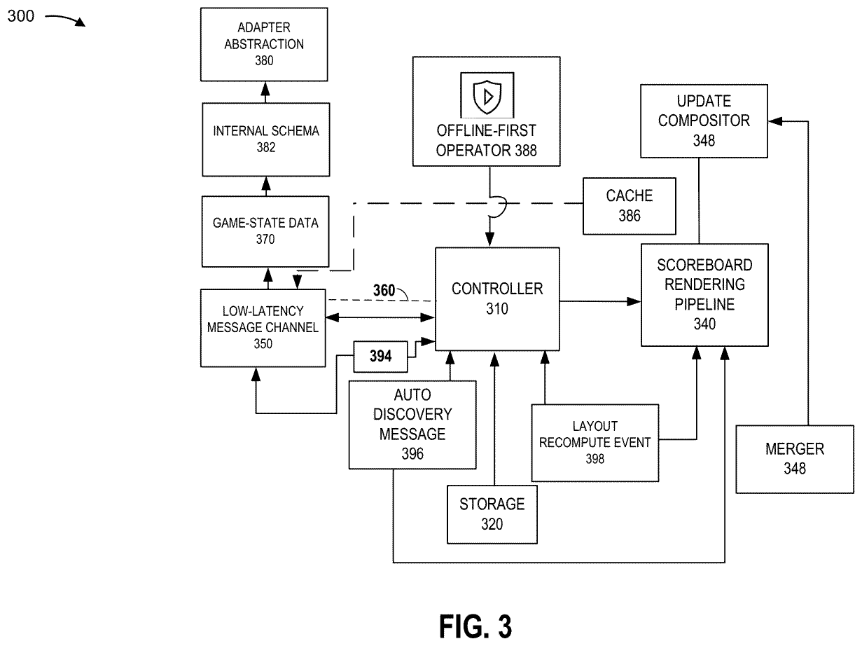

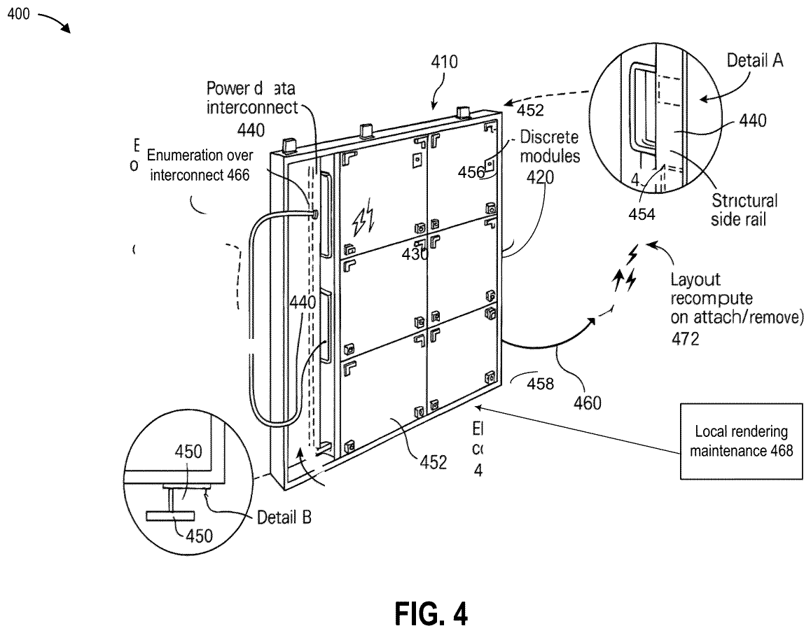

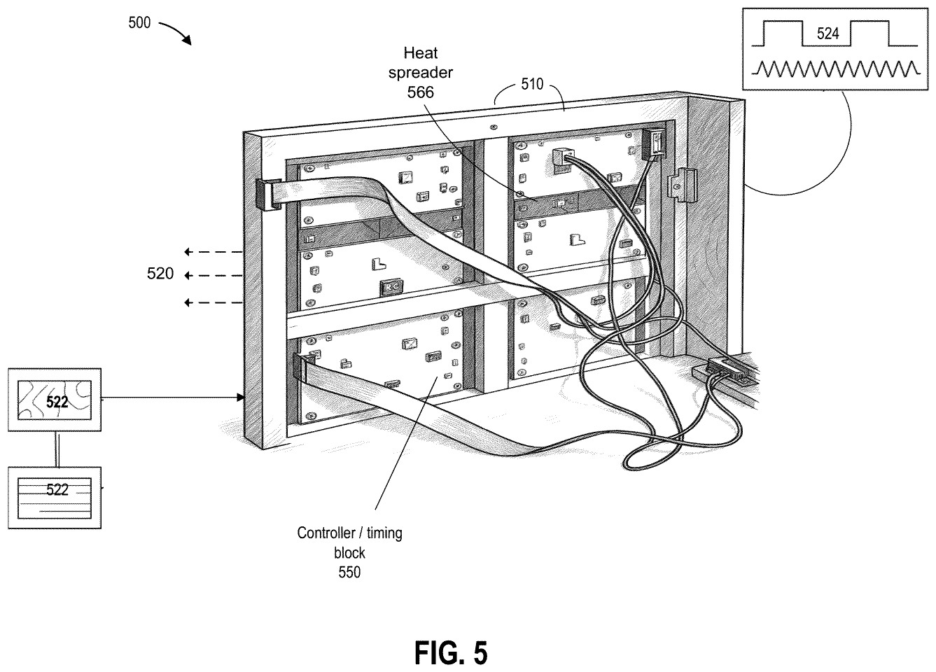

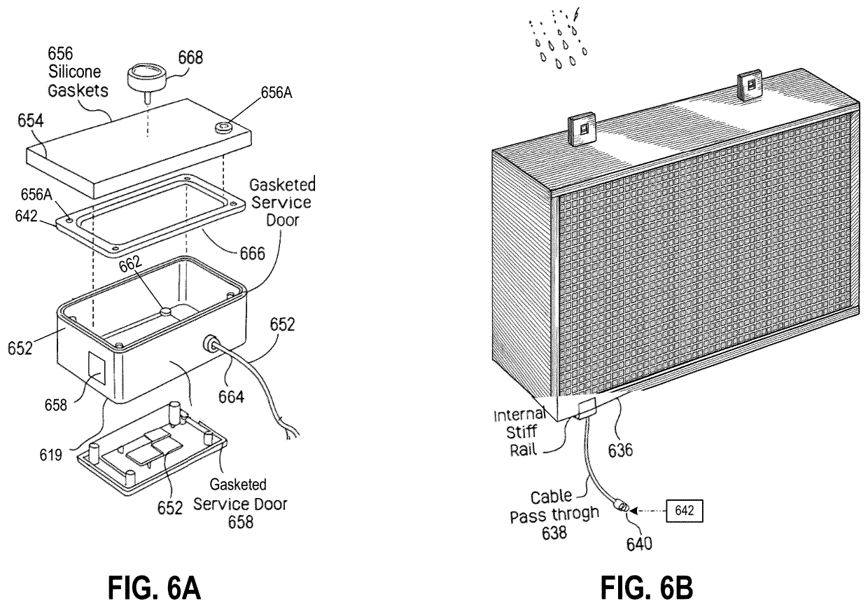

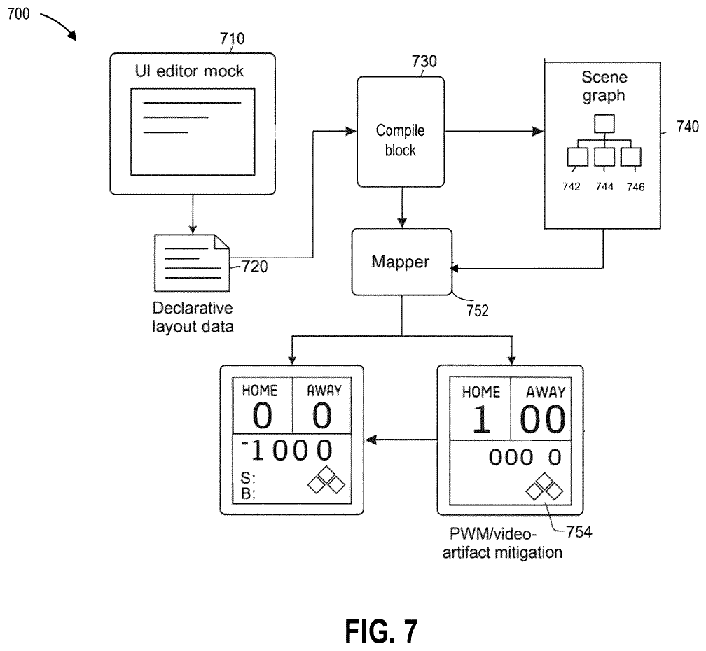

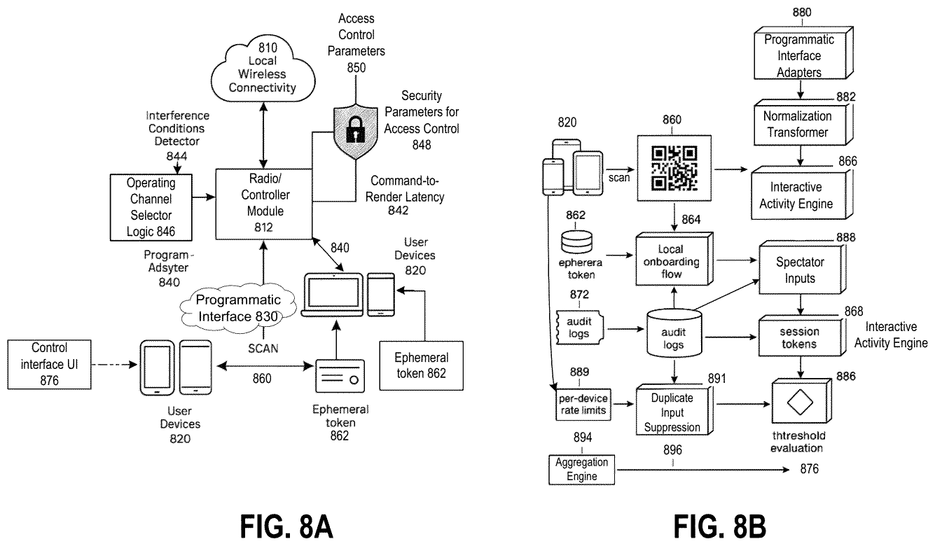

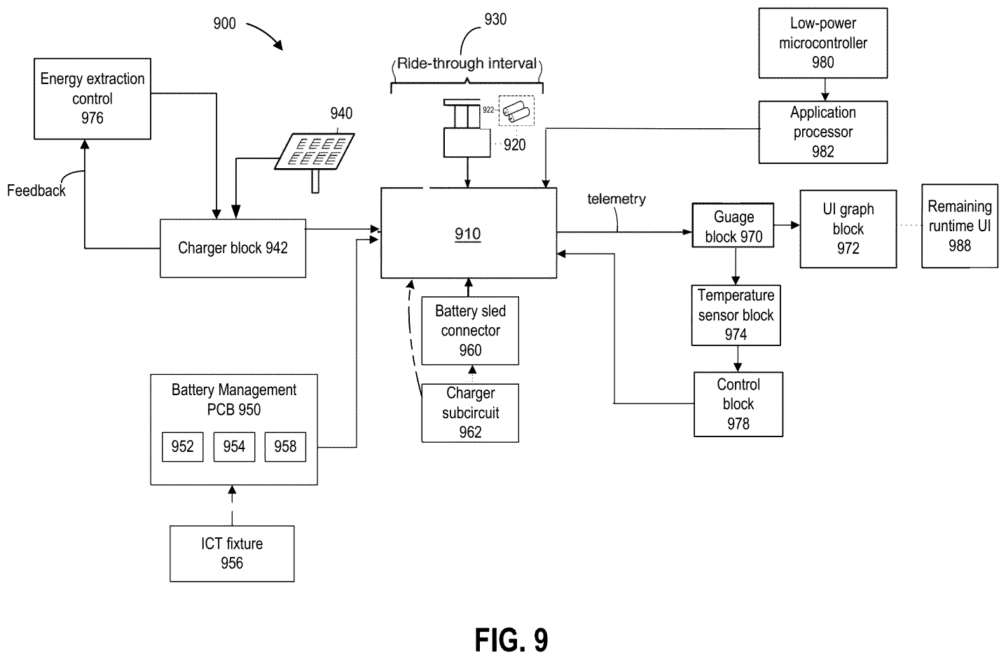

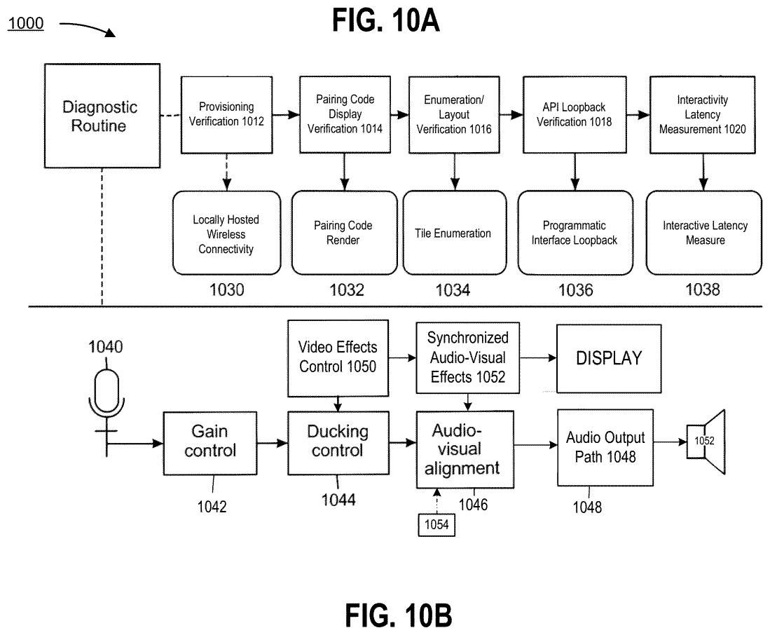

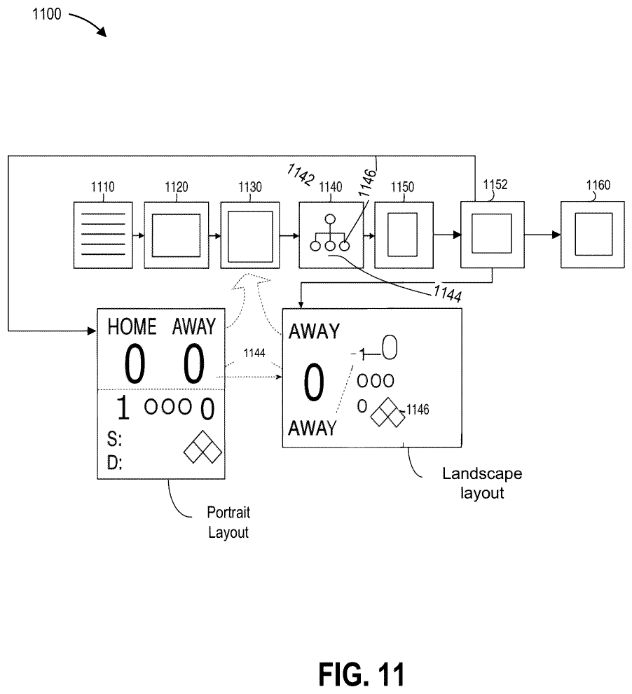

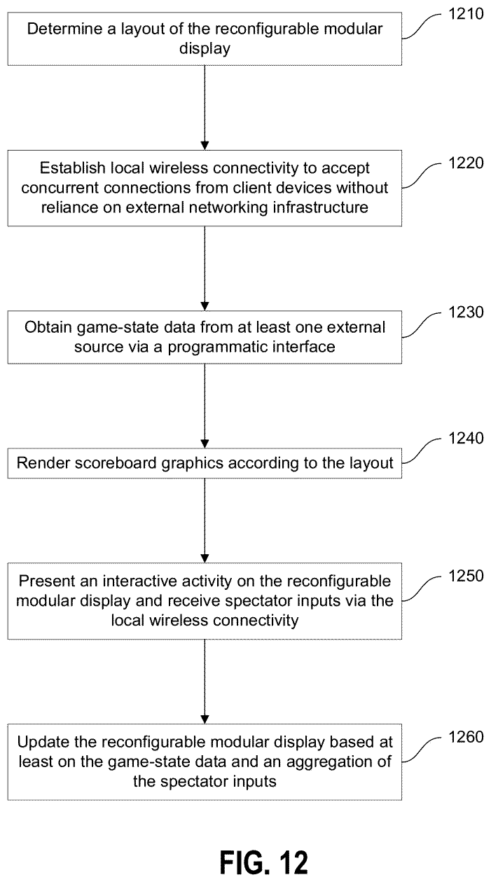

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment 100 in which systems and/or methods described herein may be implemented. As shown in FIG. 1, the environment 100 may execute within a cloud computing system 102. The cloud computing system 102 may include one or more elements 103-113, as described in more detail below. As further shown in FIG. 1, the environment 100 may include a network 120, a first user device 130, and/or a base station 140. Devices and/or elements of the environment 100 may interconnect via wired connections and/or wireless connections. It is important to note that first user device 130, as described herein, is a user device which may be used by the first user and/or the second user. In the later case, when it is used by the second user, user device 130 may also be called a second user device 130. For purposes of convenience in reading this description, the embodiment of the user device 130 as a first user device will be described, but it should be understood as interchangeably termed “second user device”at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 can operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 110. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 120 includes one or more wired and/or wireless networks. For example, the network 120 may include a cellular network, a public land mobile network (PLMN), a local area network (LAN), a wide area network (WAN), a satellite network, a private network, the Internet, and/or the like, and/or a combination of these or other types of networks. The network 120 enables communication among the devices of the environment 100.

First user device 130 may be possessed by a first user and includes one or more devices capable of receiving, generating, storing, processing, and/or providing information, as described elsewhere herein. First user device 130 may include a communication device and/or a computing device. For example, first user device 130 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 140 may support, for example, a cellular radio access technology (RAT). The base station may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the base station 140. The first user device 130 may transfer traffic between the base station 140 (e.g., using a cellular RAT), one or more base stations (e.g., using a wireless interface or a backhaul interface, such as a wired backhaul interface), and/or a core network. The first user device 130 may provide one or more cells that cover geographic areas.

The second user device 150 may be possessed by a second user and includes one or more devices capable of receiving, generating, storing, processing, and/or providing information, as described elsewhere herein. Second user device 150 may include a communication device and/or a computing device, and may be connected to, or embedded anywhere within, a vehicle or other equipment known to be utilized in the transportation industry. For example, second user device 150 may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 is a diagram of components of first user device 130, according to an example of the present disclosure. First user device 130 may include a bus 210, a processor 220, a memory 230, a storage component 240, an input component 250, an output component 260, a communication interface 270, and battery module 290.

Bus 210 includes a component that permits communication among the components of First user device 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 220. In some embodiments, a non-transitory computer-readable medium stores instructions that, when executed by a processor, cause the processor to perform various functions.

Storage component 240 stores information and/or software related to the operation and use of First user device 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 130 (e.g., a display, a speaker, a user interface, and/or one or more light-emitting diodes (LEDs)). Output component 260 may include a display providing a GUI, such as interface 300. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 130 to communicate with other devices, such as via a wired connection, a wireless connection, or a combination of wired and wireless connections. Communication interface 270 may permit first user device 130 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. Wireless algorithm component 280 may implement various communications processes and protocols, as described herein. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 130. Battery module 290 may supply power during field measurements by first user device 130. Battery module 290 permits First user device 130 to be a portable integrated device for conducting field measurements of propagation delay in a RAN.

First user device 130 may perform one or more processes described herein. First user device 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, first user device 130 may include additional components, fewer components, different components, or differently arranged components than those shown in FIGS. 2, 200. Additionally, or alternatively, a set of components (e.g., one or more components) of first user device 130 may perform one or more functions described as being performed by another set of components of first user device 130.

FIG. 2 is a diagram of components of first user device 130, according to an example of the present disclosure. First user device 130 may include a bus 210, a processor 220, a memory 230, a storage component 240, an input component 250, an output component 260, a communication interface 270, battery module 290 and matching algorithm component 210.

Bus 210 includes a component that permits communication among the components of First user device 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. According to an example, processor 220 is processor 220 of FIG. 6. Memory 230 may include one or more memories such as a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of First user device 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 130 (e.g., a display, a speaker, a user interface, and/or one or more light-emitting diodes (LEDs)). Output component 260 may include a display providing a GUI, such as interface 300. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 130 to communicate with other devices, such as via a wired connection, a wireless connection, or a combination of wired and wireless connections. Communication interface 270 may include one or more short range communication interface modules and medium/long range communication interface modules, and may permit first user device 130 to receive information from another device and/or provide information to another device. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 130. Battery module 290 permits First user device 130 to be a portable integrated device for conducting field measurements of propagation delay in a RAN.

First user device 130 may perform one or more processes described herein. First user device 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Example embodiments second user device 150 may include a mobile device/user equipment (UE) 202, a personal computer 204, or a virtual computing system 206 which may include various implementations such as those of 106. Thus, implementations described herein are not limited to any specific combination of hardware circuitry and software.

The number and arrangement of components shown in FIG. 2 are provided as an example. In practice, first user device 130 may include additional components, fewer components, different components, or differently arranged components than those shown in FIG. 2. Additionally, or alternatively, a set of components (e.g., one or more components) of first user device 130 may perform one or more functions described as being performed by another set of components of first user device 130.

### Systems and Methods for Portable Digital Scoreboards With LED Displays and Wireless Control

Referring to FIG. 3, which illustrates a system core architecture for a portable, wireless-controlled LED scoreboard, a portable scoreboard controller 310 may coordinate networking, external data ingestion, layout computation, rendering, interactivity, and power-aware behaviors to drive a reconfigurable modular display formed from display tiles interconnected by a power and data interconnect. The portable scoreboard controller 310 may be realized as a single-board computer, a microcontroller-based platform, or a heterogeneous combination, and may expose device I/O for display, storage, radios, and sensor inputs consistent with the disclosures herein. In certain aspects, the portable scoreboard controller 310 may operate in an offline-first mode and may host local interfaces for operator and spectator devices while maintaining optional synchronization with remote services.

In various aspects, a non-transitory machine-readable storage medium 320 may store instructions and data enabling the portable scoreboard controller 310 to perform layout determination, scene composition, messaging, and update operations. The non-transitory machine-readable storage medium 320 may include flash memory, eMMC, removable solid-state storage, or other persistent media and may cache program images, schema definitions, adapter configurations, and recorded events used by diagnostic routines and audit logging. The non-transitory machine-readable storage medium 320 may persist an internal schema used by the controller for normalized game-state modeling and may maintain local copies of configuration assets such as fonts, themes, and scene templates usable by the rendering pipeline.

In some aspects, layout determination logic 330 may compute a current tile arrangement by interrogating the power and data interconnect, producing a tile map used to locate visual elements on the reconfigurable modular display. The layout determination logic 330 may react to events that signal attachment or removal of a tile, or a change in addressing, orientation, or bank assignment, and may derive a two-dimensional layout with origin, spacing, rotation, and per-tile capabilities such as color depth or maximum brightness. To support dynamic configurations, an autodiscovery message 396 may be broadcast across the interconnect to request unique identifiers from the display tiles, and a layout recompute event 398 may be emitted to initiate re-layout and scene reflow when a tile presence or property changes.

In other aspects, a scoreboard rendering pipeline 340 may compose a scene graph that includes team identifiers, digits, icons, animation layers, and interactive overlays, and may map that scene graph onto the tile map produced by the layout determination logic 330. The scoreboard rendering pipeline 340 may include text shaping, sprite caching, z-ordering, region clipping, and gamma correction that together produce frame buffers compatible with the interconnect signaling used by the display tiles. The scoreboard rendering pipeline 340 may be configured to operate in a single-sided configuration or a dual-sided configuration, and may coordinate refresh phases across independent arrays when present, allowing different content to be presented on respective sides while maintaining a phase relationship that reduces perceptible artifacts.

In several aspects, an update compositor 348 may combine normalized game-state data with operator edits and spectator aggregation results to produce a coherent update applied to the scene graph. The update compositor 348 may receive inputs from a role-segmented operator interface and from an interaction engine that aggregates spectator responses, and may apply a deterministic conflict policy 384 using per-field timestamps, priority tags, and source provenance to reconcile concurrent changes. The update compositor 348 may then enqueue an atomic update to the scoreboard rendering pipeline 340, which may produce a consistent frame sequence under a command-to-render latency bound 360.

In many aspects, a low-latency message channel 350 may provide a bidirectional transport between the portable scoreboard controller 310 and connected client devices, and may carry control commands, acknowledgments, and telemetry. The low-latency message channel 350 may use a persistent socket transport, a datagram stream, or a mixed mode and may implement heartbeats, back-pressure, and rate limiting so that interactive activities remain responsive under variable wireless conditions. The command-to-render latency bound 360 may represent a configured target or measured metric used by the portable scoreboard controller 310 to adapt rendering cadence, effect density, or input batching to maintain a responsive operator experience.

In certain aspects, game-state data 370 may include team names, numeric scores, period or inning indicators, pitch or possession counts, time values, and sport-specific fields and may be obtained via an adapter layer. An adapter abstraction 380 may define a uniform interface for a plurality of external scoring services and may implement translation, authentication, retry, and backoff behaviors for each service. The adapter abstraction 380 may emit responses in an internal schema 382, which may be a canonical model with typed fields, normalization of names and identifiers, and optional extensions for sport-and league-specific attributes. The internal schema 382 may be persisted in the non-transitory machine-readable storage medium 320 to provide consistent modeling across cold starts and software updates.

In some aspects, cached data with retry/backoff 386 may maintain durable storage of received and to-be-sent messages to support offline-first operation 388. The cached data with retry/backoff 386 may record outbound events from operators, inbound snapshots from external services, and reconciliation outcomes from the deterministic conflict policy 384, allowing eventual synchronization when a programmatic interface is available. The offline-first operation 388 may bias the scoreboard rendering pipeline 340 to continue rendering using the most recent local state even when the adapter abstraction 380 or a remote service is temporarily unavailable.

In various aspects, an ingestion interface 394 may provide a software and network stack through which the portable scoreboard controller 310 communicates with external services. The ingestion interface 394 may include a local access point service, optional client-mode networking, and connection management to remote endpoints. The ingestion interface 394 may enforce security parameters for access control, may select an operating channel based on interference conditions among co-located scoreboards, and may establish a secure transport for remote synchronization while leaving the low-latency message channel 350 available for on-site control.

In other aspects, the autodiscovery message 396 may include a discovery opcode, a controller identifier, and a nonce, and each display tile may respond with a unique identifier, capability flags, and an optional positional hint. The layout recompute event 398 may be generated when a tile appearance, disappearance, or property change is detected, and the layout determination logic 330 may recompute the tile map and may notify the scoreboard rendering pipeline 340 that the scene graph should be re-mapped. In certain aspects, the scoreboard rendering pipeline 340 may maintain continuity of visual elements by re-anchoring bounding boxes and re-allocating glyph meshes according to the updated tile map.

In many aspects, the portable scoreboard controller 310 may be configured to establish local wireless connectivity that accepts concurrent connections from operator and spectator devices without reliance on external networking infrastructure. A local onboarding flow may render a machine-readable pairing code on the display tiles, may issue role-based session credentials upon successful onboarding, and may partition operator control channels from spectator traffic over the low-latency message channel 350. Operator sessions may modify fields in the internal schema 382, while spectator sessions may provide inputs to interactive activities that the update compositor 348 aggregates over defined time windows.

In certain aspects, the portable scoreboard controller 310 may apply sensor inputs such as ambient-light measurements to compute brightness adjustments in the scoreboard rendering pipeline 340 or in a driver layer that modulates duty cycles for the display tiles. The low-power microcontroller and application processor configuration described elsewhere may be used to maintain low-power standby states, and a power-management subsystem may maintain ride-through behavior during a battery exchange; these may be represented within the portable scoreboard controller 310 as control subsystems that supply power state and timing notifications to the update compositor 348 and the scoreboard rendering pipeline 340.

In some aspects, the system of FIG. 3 may be implemented within the enclosure structures shown in other figures as an example embodiment of the same architectural partitioning. For example, the portable scoreboard controller 310 may reside in the controller bay of a hinged enclosure with door-mounted tile arrays, the non-transitory machine-readable storage medium 320 may be a module on the controller board, and the power and data interconnect queried by the layout determination logic 330 may be embodied as HUB-style ribbon cabling for data with a daisy-chain power harness supplying per-tile connectors. In other aspects, the reconfigurable modular display may be realized as a monolithic panel that exposes a logical tile interface compatible with the autodiscovery message 396 and layout recompute event 398.

In several aspects, diagnostic routines stored in the non-transitory machine-readable storage medium 320 may verify provisioning of local wireless connectivity, display of the machine-readable pairing code, enumeration and layout formation, programmatic interface loopback via the ingestion interface 394, and interactive activity latency against acceptance thresholds. These routines may publish results over the low-latency message channel 350 for device-side visualization or logging to the non-transitory machine-readable storage medium 320 and may assist with end-of-line testing during manufacturing and field-service workflows.

In many aspects, an end-to-end operation may proceed by the portable scoreboard controller 310 initializing the adapter abstraction 380 and the ingestion interface 394, broadcasting the autodiscovery message 396 and receiving tile responses used by the layout determination logic 330 to produce the tile map, composing a default scene in the scoreboard rendering pipeline 340 based on the internal schema 382, and accepting operator onboardings via the local onboarding flow over the low-latency message channel 350. When external services are reachable, game-state data 370 may be normalized to the internal schema 382 and supplied to the update compositor 348, which may merge those updates with operator edits and spectator aggregation results under the deterministic conflict policy 384 and push a coherent update to the scoreboard rendering pipeline 340, maintaining responsiveness relative to the command-to-render latency bound 360.

In some aspects, alternate deployments may distribute the adapter abstraction 380 and ingestion interface 394 onto a separate gateway that communicates with the portable scoreboard controller 310 over a local link, while maintaining the same internal schema 382 and update compositor 348 semantics on the controller. In other aspects, the portable scoreboard controller 310 may be embedded in a dual-sided enclosure, and the scoreboard rendering pipeline 340 may produce independent frame streams for each side while sharing the same internal schema 382 and update compositor 348. In many aspects, the architectural partition of FIG. 3 may accommodate sport-agnostic layouts, modular hardware growth, and optional audio subsystems that align audio cues to visual events triggered by the update compositor 348 and delivered via the scoreboard rendering pipeline 340.

In certain aspects, the portable scoreboard controller 310 may include an application processor with a clock rate between approximately 600 MHz and 2.5 GHz and a companion microcontroller operating between approximately 32 kHz and 240 MHz, where separate power domains may be gated to reduce idle draw while preserving timing and state for recovery after suspend, and where a secure element may be present to store cryptographic material used by the ingestion interface 394 and adapter abstraction 380 for authenticating to external services. The portable scoreboard controller 310 may implement a hardware abstraction layer that exposes uniform interfaces for frame transmission, peripheral I/O, timing, and logging such that a rendering driver may be swapped without changes to scene-composition code, and such that an alternate tile interconnect driver may be selected at build time or runtime to support different buses, for example SPI-banked drivers or differential multi-drop links.

In some aspects, the non-transitory machine-readable storage medium 320 may be realized as eMMC in a range between approximately 4 GB and 128 GB, NOR flash sized between approximately 8 MB and 256 MB for boot firmware, and removable media for content packages such as fonts or animations, and journaling file systems may be used to reduce corruption risk when abrupt power loss occurs during write operations. Wear-leveling and bad-block management may be applied, and configuration snapshots for the internal schema 382 may be versioned such that downgrades or rollbacks may be performed when the update compositor 348 adopts a new field that is not recognized by prior releases.

In various aspects, the layout determination logic 330 may compute a tile map by receiving responses to an autodiscovery message 396 that include a tile unique identifier, a bank identifier, and capability bits covering pixel pitch, color depth, refresh constraints, and optional temperature derating hints, and a constrained optimization may be used to place logical regions of the scene graph across the tile map subject to continuity penalties when tile borders intersect digits or icons. A two-dimensional affine transform matrix may be computed for each tile when rotation is reported, and an occlusion set may be generated if enclosure bezels or mechanical frames reduce visible area at specific edges; the occlusion set may be used by the scoreboard rendering pipeline 340 to avoid drawing into non-visible pixels. A layout recompute event 398 may trigger a two-phase update where a first phase freezes input to modify elements while a second phase remaps nodes and resumes command processing under a throttled rate to keep the command-to-render latency bound 360 within a configured envelope.

In other aspects, the scoreboard rendering pipeline 340 may include glyph rasterization using signed-distance fields, sprite atlases compressed with run-length encoding or block-based schemes, per-layer alpha composition, and ordered dithering to approximate intermediate luminance levels where tiles provide a limited bit-plane budget, and gamma correction may be applied using a look-up table calibrated per tile model. Frame buffers may be prepared in a double-buffered or triple-buffered arrangement, and a framerate governor may be used to reconcile the low-latency message channel 350 throughput with interconnect timing constraints; for example, when the low-latency message channel 350 delivers a burst of operator edits and spectator inputs, the rendering cadence may be temporarily increased within safe electrical timing bounds of the interconnect to reduce perceived delay.

In several aspects, the update compositor 348 may implement a deterministic conflict policy 384 that treats the adapter abstraction 380 as one source with a priority class and operator edits as another source with a separate priority class, while per-field policies may override class defaults; a monotonic lamport-style clock or a hybrid logical clock may be used to tolerate clock skew between external services and the portable scoreboard controller 310. Field merges may be either last-writer-wins or rule-based, where a rule may specify that a manual override persists for a window before service updates resume authority, and aggregation windows for interactive activities may be aligned to animation cycles to maintain visually coherent transitions on the reconfigurable modular display.

In certain aspects, the low-latency message channel 350 may transport messages encoded as JSON, CBOR, or a binary schema with field tags, and messages may be sequenced with strictly increasing identifiers so that the portable scoreboard controller 310 can drop duplicates or reorder out-of-sequence arrivals when radio conditions vary. Heartbeats may carry a snapshot of the command-to-render latency bound 360 and the last applied scene revision, and clients may adapt their send rate by observing a congestion hint embedded in heartbeat responses. Optional datagram transports using QUIC-like semantics may be used to reduce head-of-line blocking when spectator inputs are numerous.

In many aspects, game-state data 370 may include, for baseball mode, balls, strikes, outs, inning, and base occupancy; for soccer mode, goals, period, stoppage indicators, and cautions; and for basketball mode, score, period, shot clock, and fouls, and the internal schema 382 may include a sport field to select interpretation functions used by the scoreboard rendering pipeline 340. Normalization performed by the adapter abstraction 380 may include name mapping, time-zone harmonization, and enumeration alignment such that downstream renderers may operate without adapter-specific branches.

In some aspects, the adapter abstraction 380 may load service plug-ins that define authentication flows, endpoint URIs, and parsing rules, and a plug-in may be signed and validated prior to installation to reduce the risk of malicious code. Polling strategies may be replaced by event subscriptions when services provide webhooks or server-sent events, and the ingestion interface 394 may multiplex both patterns while applying cached data with retry/backoff 386 when remote connectivity intermittently fails. A retry budget may be tracked so that energy consumption remains bounded when the portable scoreboard controller 310 operates on battery power.

In various aspects, the ingestion interface 394 may create a local access point where the SSID, channel, and security parameters may be derived from a configuration file kept on the non-transitory machine-readable storage medium 320, and a captive portal page may present a machine-readable pairing code rendered by the scoreboard rendering pipeline 340 such that operators can join with minimal steps and role-based session credentials may be issued. Channel selection may be based on a scan of neighboring beacons, and when co-located scoreboards are present, distinct channels may be chosen to reduce co-channel interference, while a coordination table may be exchanged peer-to-peer to avoid collisions in dense venues.

In other aspects, the autodiscovery message 396 may include a cyclic redundancy check and a backoff slot index so that tile responses may be de-conflicted in time, and tiles may advertise maximum sustainable current per brightness level so that the update compositor 348 can instruct the scoreboard rendering pipeline 340 to constrain duty cycles when thermal or power budgets approach configured limits. When a tile fails to respond within a configured interval, a degraded map may be created that excludes the missing tile while preserving readability; for example, numeric fields may be re-routed to known-good columns and a banner may be temporarily hidden to free pixel area.

In several aspects, alternative configurations may include a monolithic panel exposing a logical tile grid where each virtual tile ID maps to a contiguous region of pixels, a banked configuration where groups of tiles share a driver with address offsets, or a dual-sided assembly where two independent tile arrays are addressed by a single portable scoreboard controller 310 through separate ports, where each port may carry its own timing and gamma parameters. Swapping of adapter plug-ins may permit operation with distinct external scoring services, and switching between local-only and hybrid local-plus-remote operation may be performed without changing hardware.

In many aspects, software may be implemented using a high-level language such as Python or JavaScript for orchestration, with performance-critical sections of the scoreboard rendering pipeline 340 implemented in C or C++, and shaders or vectorization intrinsics may be used where available to speed glyph rasterization and color conversions. A web-based operator interface may be delivered from the portable scoreboard controller 310 using an HTTP server and a WebSocket endpoint implementing the low-latency message channel 350, and user interface assets may be bundled and cached for offline use. Build tooling may include containerized steps where the adapter abstraction 380 plug-ins and rendering assets are compiled and tested against a simulator that emulates tile responses to the autodiscovery message 396 and verifies layout recompute event 398 handling.

In certain aspects, practical deployments may include temporary fields where external network access is intermittent, school gyms where radio conditions vary across bleachers, or community events where interactive polling is useful for audience engagement, and the offline-first operation 388 may enable uninterrupted presentation by relying on locally cached data and operator inputs while the adapter abstraction 380 resumes ingestion when connectivity returns. Rental fleets may benefit from the diagnostic routines stored on the non-transitory machine-readable storage medium 320 by verifying, before dispatch, that pairing code rendering, enumeration, loopback, and latency metrics meet configured thresholds.

In some embodiments, as illustrated in FIG. 3, process flows within the portable scoreboard controller 310 may include a feedback loop in which the measured command-to-render latency bound 360 is fed back to the update compositor 348 to adjust aggregation window sizes for interactive activities, and the scoreboard rendering pipeline 340 may adapt animation durations so that perceptual smoothness is maintained across a range of device loads. While no machine learning model is required, a rules-based fine-tuning of parameters such as font thickness, outline size, and digit spacings may be performed based on tile-capability reports gathered during the autodiscovery message 396 cycle.

In various aspects, security considerations may be addressed by issuing short-lived role-based session credentials through the ingestion interface 394, recording audit entries in the non-transitory machine-readable storage medium 320 when operator actions modify the internal schema 382, and signing configuration bundles to reduce tampering risks. When the portable scoreboard controller 310 is used in institutional contexts, logs may be exported through a secure transport to a supervisory system for compliance or fleet analytics.

In other aspects, industrial applicability may include production test stations where the diagnostic sequence is executed for each unit as part of end-of-line validation, tournament operations where multiple portable scoreboard controllers 310 coordinate channels to avoid interference, and educational programs where students assemble tile arrays and observe the effects of layout recompute event 398 by adding or removing display modules. The architectural partition shown may thus be applied across custom enclosures, varied tile geometries, and distinct sports while maintaining a common software core that centers on the internal schema 382, adapter abstraction 380, update compositor 348, scoreboard rendering pipeline 340, and the low-latency message channel 350.

It shall be noted that, as illustrated in FIG. 3, the same partition may be used across a variety of industry and technological domains in which a field-portable, layout-aware, and network-flexible display is desirable, including temporary event signage for public health clinics, construction-site status boards, disaster-relief triage and logistics staging, outdoor education exhibits, transportation gate information at pop-up transit hubs, manufacturing andon or takt displays, and campus safety messaging, and the portable scoreboard controller 310 may therefore be configured to select sport-agnostic or domain-specific scene templates from the non-transitory machine-readable storage medium 320 to meet those contexts. In some embodiments, scene templates may include accessibility-oriented variants with high-contrast glyphs and larger hit targets, and the scoreboard rendering pipeline 340 may switch among such templates responsive to operator role changes received over the low-latency message channel 350. As illustrated in FIG. 3, the adapter abstraction 380 may normalize feeds from municipal open-data APIs when the system operates as a community information board, with the internal schema 382 mapping time-series advisories to banner regions while the deterministic conflict policy 384 governs precedence between automated advisories and operator-entered updates. It shall be noted that dual-sided assemblies may render distinct content on respective faces when used along pedestrian thoroughfares, and the phase coordination performed by the scoreboard rendering pipeline 340 may reduce visible artifacts on both faces when ambient illumination or viewing angles vary.

It shall be noted that many technical benefits may result from the system of FIG. 3 over conventional field displays. Firstly, unlike conventional techniques that rely on a single remote or fixed infrastructure, the local onboarding flow over the low-latency message channel 350 may admit concurrent operator sessions and spectator sessions while maintaining role segregation, thereby reducing contention and setup time. Secondly, in some embodiments, the adapter abstraction 380 coupled with the internal schema 382 may reduce integration effort by presenting a stable, canonical interface to heterogeneous external services, which may reduce parsing errors and schema drift at deployment. Thirdly, the layout determination logic 330, in cooperation with the autodiscovery message 396 and layout recompute event 398, may permit hot-add and hot-remove of tiles with bounded command-to-render latency 360, which may enhance maintainability and uptime in field conditions. Fourthly, the cached data with retry/backoff 386 and offline-first operation 388 may sustain local rendering during backhaul outages while deferring synchronization through the ingestion interface 394, which may reduce user-perceived failures in venues with intermittent connectivity. Fifthly, the deterministic conflict policy 384 may yield repeatable merges of operator edits and service updates, improving traceability when audit logs are inspected. Sixthly, phase-aware scene composition within the scoreboard rendering pipeline 340 may reduce temporal artifacts on tile arrays and dual-sided assemblies, improving readability in high-motion scenes. Seventhly, channel selection and access-control parameters configured by the ingestion interface 394 may mitigate co-channel interference when co-located units operate in proximity.

In some embodiments, as illustrated in FIG. 3, a closed-loop adaptation may be implemented in which a measured command-to-render latency 360 is periodically fed back to the update compositor 348 to adjust aggregation windows for interactive activities and to the scoreboard rendering pipeline 340 to tune animation durations and throttling parameters, and such feedback may maintain responsiveness across a range of operator and spectator loads without changing scene semantics. It shall be noted that, when the system is repurposed for industrial counters or environmental dashboards, game-state data 370 may be interpreted as production counts, station states, or sensor vectors, respectively, while preserving the dataflow through the adapter abstraction 380, the internal schema 382, and the update compositor 348, and that security parameters of the ingestion interface 394 may be applied identically to those domains. In some embodiments, the portable scoreboard controller 310 may log diagnostic traces to the non-transitory machine-readable storage medium 320 during end-of-line tests so that fleet operators may later correlate field issues with provisioning events, enumeration cycles, and programmatic interface loopbacks recorded at deployment.

Referring to FIG. 4, a reconfigurable modular display 410 may be formed as an aggregate display assembly in which multiple display tiles 420 may be mechanically and electrically coupled to a backplane 450 through a power and data interconnect 440 so that the physical size and logical layout of the display may change by adding or removing tiles. The reconfigurable modular display 410 may be oriented in portrait or landscape orientations and may be mounted in an enclosure or frame not shown in this view. In some embodiments, as tiles 420 are attached or removed, a controller described elsewhere may detect the change over the interconnect 440, perform enumeration over interconnect 466, and initiate layout recompute on attach/remove 472 so that scene content remains legible across the revised pixel map while local rendering maintenance 468 may continue rendering without interruption.

Each display tile 420 may include an emissive pixel matrix (e.g., RGB LED matrix, micro-LED, mini-LED), an LCD panel with a backlight, or an e-paper module, and a tile unique identifier (NVM) 430 may be stored on the tile in non-volatile memory such as EEPROM or flash. The tile unique identifier (NVM) 430 may encode a globally unique ID, a model code, capability flags for color depth and refresh, and optional calibration values. A tile mechanical attachment 458 may include screws, quarter-turn fasteners, spring clips, or tool-less latches that engage with features on the backplane 450 or the elongated rail (structural) 452 so that field replacement may be performed with minimal tools. In some embodiments, rubber isolation washers or compliant standoffs may be used within the tile mechanical attachment 458 to reduce vibration transmission and to maintain coplanarity across adjacent modules.

The backplane 450 may include mechanical structure and an electrical distribution network for the power and data interconnect 440. The elongated rail (structural) 452 may be realized as an extruded aluminum section or molded polymer beam that includes an internal conduit 454 sized to route the power and data interconnect 440 in a protected channel. The internal conduit 454 may be open on one side for service access or closed and gasketed to improve ingress resistance. A cross-section of the elongated rail 452 may define dovetail grooves for sliding nut plates or formed bosses for direct thread-forming fasteners, and may include heat-spreading lands that contact the rear faces of tiles 420 to improve thermal conduction. In some embodiments, apertures may be formed through the elongated rail 452 for mounting to an external frame or enclosure; such apertures may be used with bolts, rivets, or hook hardware to hang the reconfigurable modular display 410 on a fence or wall. When apertures are present, they may be optional features that could also include bushings or reinforcement rings to distribute load.

The power and data interconnect 440 may distribute regulated DC power and signaling to each tile 420. The interconnect 440 may include separate conductors for power and for differential data signaling, or a hybrid bus in which power and signaling share a cable with shielding and drain wire. Data lines may be arranged as a daisy-chain, a multi-drop bus, or a banked star topology. Line coding may include NRZ, Manchester, or other encodings compatible with the tile drivers, and link rates may be selected to match the pixel clock and color depth of the tiles 420. Polarized waterproof multi-pin connectors 456 may mate each tile 420 to the power and data interconnect 440 through openings in the elongated rail 452 or the backplane 450 so that mis-mating is reduced during field service. In some embodiments, keyed housings with o-ring gaskets may be used for the polarized waterproof multi-pin connectors 456 to increase environmental resilience.

Electrical coupling to interconnect 460 may be provided by a harness or printed conductor set that links the backplane 450 to a controller described in other figures. The electrical coupling 460 may include detachable bulkhead connectors to permit enclosure door removal, or strain-relieved pigtails to accommodate door swing and vibration. Over-current protection devices and transient suppression may be included in the electrical coupling 460 or the power and data interconnect 440 so that fault containment is improved when a tile is damaged. In some variants, the backplane 450 may include shunt regulators or load-sharing modules to support hot-swapping of tiles 420 while local rendering maintenance 468 continues to display content on remaining tiles.

The enumeration over interconnect 466 may be initiated when power is applied or when a physical change is sensed. A discovery broadcast may request that each tile 420 respond in a time slot derived from the tile unique identifier (NVM) 430 to reduce collisions. A response may include the identifier, supply voltage and temperature readings, and capability flags. The controller may assemble a tile map and derive a layout for the reconfigurable modular display 410. When a mismatch between the expected and reported set of tiles is detected, a layout recompute on attach/remove 472 may be triggered. During the recompute, the controller may temporarily pause non-essential animations and reflow scene elements to avoid placing glyphs across a boundary between non-contiguous tiles.

Local rendering maintenance 468 may indicate that the display may continue to output frames using locally available data when network connectivity to remote services is unavailable. Cached score values and recently received operator commands may be retained and presented while the adapter abstraction described elsewhere is offline. When connectivity resumes, newly received updates may be merged by a deterministic policy at the controller level without requiring changes to the physical assembly shown in FIG. 4. In some embodiments, a visual indicator such as a small icon or banner may be rendered to note operation in a local-only mode; in other embodiments, the indicator may be omitted for venues where minimal on-screen status messaging is desired.

The monolithic panel with logical tile interface 462 may represent an alternate configuration in which a single large display substrate replaces multiple discrete tiles while presenting to the controller a logical grid of virtual tiles. In such a configuration, virtual unique identifiers may be assigned at the controller and stored in configuration memory such that enumeration over interconnect 466 may still be performed and layout recompute on attach/remove 472 may be simulated by enabling or disabling virtual tiles. The monolithic panel with logical tile interface 462 may allow manufacturers to offer a seamless front surface while retaining the software behaviors that simplify adaptation across different physical models.

The tile mechanical attachment 458 and the elongated rail 452 may cooperate to provide a planar datum across the reconfigurable modular display 410. Shim packs or adjustable brackets may be included so that small variations in panel thickness are accommodated. In some embodiments, compressible gaskets may be placed between adjacent tiles 420 to reduce light bleed in emissive displays, while a shared diffuser may be used for LCD implementations. The internal conduit 454 may contain separate sub-channels for power and data to limit crosstalk, and a continuous ground reference may be routed along the elongated rail 452 to reduce electromagnetic emissions. Where heat must be removed, the elongated rail 452 may be coupled to a heat spreader plate or finned extrusion on the rear of the assembly.

The polarized waterproof multi-pin connectors 456 may carry, by way of example, V+, return, differential data pair(s), a tile-present sense line, and an optional reset line. Contact plating may include tin or gold; housing materials may include polyamide or polycarbonate with elastomeric seals. When LCD or e-paper tiles are used, a backlight or front-light connector may be added to the pinout. In emissive configurations, driver ICs on each tile 420 may implement bit-plane PWM, and the controller may provide gamma-corrected plane weights so that a modulation scheme that reduces visible artifacts may be achieved when the display is recorded by cameras with rolling shutters.

The reconfigurable modular display 410 may include alignment features along edges of the tiles 420 to assist with assembly. Edge keys or locating pins may be used to maintain tight seams. The backplane 450 may include test pads accessible with a bed-of-nails fixture so that continuity and signal integrity of the interconnect 440 may be verified during manufacturing. For deployments that require rapid setup, the elongated rail 452 may include captive quarter-turn fasteners for tiles 420 and latching bulkhead connectors for the electrical coupling 460 so that assembly may be accomplished by non-specialist personnel.

In some embodiments, the backplane 450 may integrate a microcontroller that proxies enumeration over interconnect 466 to the main controller, tracks tile health states reported through the tile unique identifiers (NVM) 430, and mediates power sequencing to inrush-limit tile power rails during attach events. The backplane microcontroller may maintain a simple table of tile identifiers and positions that may be read by the main controller, reducing bus traffic when only a small number of tiles change over time. When the reconfigurable modular display 410 is folded or stowed, flex regions of the interconnect 440 may be protected by bend-radius guides integrated into the elongated rail 452.

The electrical coupling to interconnect 460 may route through a hinged door or removable cover in other figures. Strain relief loops and grommets may be included where conductors exit an enclosure. In high-moisture contexts, potting or conformal coating may be applied within the internal conduit 454 around splice points or connector backshells to increase durability. For applications that must meet stricter ingress-protection ratings, the polarized waterproof multi-pin connectors 456 and the elongated rail 452 may be selected with higher seal compression and materials rated for UV exposure.

In some embodiments, the reconfigurable modular display 410 may be assembled as a dual-sided unit in which two tile arrays 420 are mounted back-to-back on a common spine formed by the elongated rail 452, and the electrical coupling 460 may include two independent data groups with shared or independent power feeds. In such configurations, content presented on each side may be independent, and refresh timing may be coordinated by the controller to reduce visual artifacts when viewed from off-axis angles. For transport, optional corner guards or a soft-case sleeve may be used; these features may be optional and need not be present in the simplest embodiment.

The monolithic panel with logical tile interface 462 may be particularly suited to large indoor applications where a continuous glass or polycarbonate front surface is preferred. In such cases, a logical grid may be defined within controller software so that scene layout, autodiscovery semantics, and reflow behaviors remain consistent with multi-tile embodiments. If a sub-region of the monolithic panel fails, the controller may simulate tile removal for that region and remap content using layout recompute on attach/remove 472 to maintain readability around the affected area.

When used with the system-level architecture described elsewhere, the structures in FIG. 4 may enable automatic onboarding. For example, after initial power-up, enumeration over interconnect 466 may populate a tile map; a pairing code may then be rendered on the reconfigurable modular display 410; operators may join via local connectivity; and content may be rendered and updated while local rendering maintenance 468 sustains output during any upstream service interruptions. The modular behaviors shown in FIG. 4 may therefore support portable deployments, rapid servicing, and scalable display sizes while aligning with software mechanisms for discovery, layout determination, and rendering.

Referring to FIG. 5, a dual-sided configuration 510 may be realized as a back-to-back assembly in which two reconfigurable modular displays are mounted on opposite faces of a common enclosure spine so that content may be presented toward two viewing directions while sharing controller, power, and mechanical infrastructure. The dual-sided configuration 510 may be used in fields, gymnasiums, or pedestrian corridors where spectators stand on opposite sides of a barrier, and the structure may be dimensioned to balance mass and stiffness so that the unit may be suspended from a fence or mounted on a tripod without excessive torsion. In some embodiments, an enclosure may include optional apertures for hooks or carabiners; such apertures, when present, may be considered optional features and could also include grommets or metal bushings to distribute load, and they may not be required for the simplest embodiment of the dual-sided configuration 510. When integrated with the portable scoreboard controller described elsewhere, the dual-sided configuration 510 may permit the controller to compute independent layouts per side while maintaining shared state for timing and inputs.

Dual-sided arrays 520 may include a first tile array on a front face and a second tile array on a rear face, each formed of display tiles assembled into rectangular or non-rectangular matrices that may differ in pixel pitch, color depth, or maximum luminance depending on venue requirements. The dual-sided arrays 520 may be secured to a central rail-and-backplane spine with fasteners, quick-release latches, or slide-in brackets, and electrical coupling may be provided by two power-and-data harnesses routed through a protected internal conduit within the spine. In some embodiments, the front tile array may employ a higher pixel density for closer viewers while the rear tile array may use larger pitch for long-distance viewing, and each array may be enumerated over the interconnect so that a tile map and scene layout are computed on a per-side basis. The dual-sided arrays 520 may be co-planar with their respective bezels to maintain consistent viewing angles and to reduce moiré when recorded on consumer cameras.

Independent content per side 522 may allow the controller to render different scenes on the front and rear tile arrays simultaneously. For example, the field-facing side may present team names, scores, inning or period indicators, and count fields, while the spectator-concourse side may present sponsor banners, a QR pairing code for local onboarding, or an interactive activity such as a poll or trivia prompt. The independent content per side 522 may be configured through a role-aware web interface in which operators assign scenes to the “A” and “B” faces and select sport presets and color themes independently. In some embodiments, the controller may mirror only certain data fields (e.g., scores) while allowing auxiliary content to differ; in other embodiments, the system may present entirely unrelated layouts per face, and each layout may be derived from a scene graph that is mapped to the corresponding tile map computed during enumeration.

Refresh phase coordination 524 may establish a timing relationship between the first and second arrays to reduce perceptible artifacts such as beat flicker or rolling-shutter banding when both faces are observed simultaneously or when camera recordings include both faces. The refresh phase coordination 524 may be specified as a relative phase offset between frame starts or sub-frame bit-plane transitions, and the offset may be computed based on measured propagation delay in the cabling and per-array driver characteristics. For PWM-based LED drivers, the controller may shift bit-plane scheduling so that high-energy planes on opposite faces are not driven concurrently, which may reduce instantaneous current peaks and electromagnetic emissions. When the arrays have different pixel clocks or color depths, phase coordination may be achieved through least-common-multiple cycles where frame boundaries are aligned at a lower-frequency epoch while maintaining near-independent high-frequency timing per array.

A phase coordinator 550 may implement the refresh phase coordination 524 as a software timing unit, a hardware timer peripheral, or a hybrid FPGA or CPLD block that gates update strobes to each face. The phase coordinator 550 may receive a global timebase from the application processor or a low-power microcontroller and may expose registers through which a scheduler in the controller sets per-face phase offsets, frame period targets, and guard intervals. In some embodiments, the phase coordinator 550 may measure current draw or bus voltage sag and apply small phase adjustments to reduce peak loading, and such adjustments may be bounded so that the command-to-render latency target is maintained. Where electromagnetic compatibility limits apply, the phase coordinator 550 may dither update timing within a narrow window to spread spectral energy while keeping visual artifacts below perceptual thresholds.

A heat spreader 566 may be thermally coupled to the central spine or elongated rail so that heat from both tile arrays may be conducted away from driver ICs and LEDs. The heat spreader 566 may be formed from aluminum or copper plate with thermal interface pads contacting the rear of each tile, and fins or folded louver structures may be integrated along edges to improve natural convection. In some embodiments, the heat spreader 566 may include a vapor chamber or heat pipe routed along the spine, and the assembly may be modeled so that thermal gradients across each face remain within operating limits under expected ambient conditions. The controller may optionally derate brightness when a temperature sensor coupled to the heat spreader 566 exceeds a threshold, and the derating may be applied independently per face if sensor placement allows per-face discrimination.

The mechanical integration of the dual-sided configuration 510 may include a common center spine that locates the dual-sided arrays 520 and provides mounting points for brackets and suspension hardware. The spine may incorporate the protected conduit for power and data and may present bulkhead connectors for the harness from the controller bay. In serviceable designs, each face may be removable independently so that tiles on one side may be replaced without disturbing the other. Gaskets or edge seals may be applied around each array to limit water ingress and to control light leakage between tiles, and the overall assembly may target ingress-protection ratings appropriate for outdoor deployment. Optional hoods or louvers may be included on one or both faces to reduce glare in bright sun; when present, such hoods may be removable and may not be required in baseline configurations.

Power distribution to the dual-sided arrays 520 may be shared or separated. In a shared-bus variant, a single regulator or battery pack may feed both faces, while the phase coordinator 550 and the controller's power manager adjust duty cycles and phase to keep peak current within limits. In a separated-bus variant, independent regulators may feed each face, and a common battery pack may be split by ideal-diode power-path circuitry to allow one face to continue operation if the other face is serviced or temporarily disconnected. Hot-swap operation may be supported by hold-up capacitors and a bus pre-charge circuit so that either face may be reconnected without causing a visible dropout on the other.

Signal routing for independent content per side 522 may be handled by two data ports on the controller, or a single high-bandwidth link may be time-division multiplexed and de-serialized near the arrays. In the latter case, a small deserializer module mounted near each face may recover per-face streams under direction of the phase coordinator 550. Enumeration of tiles on each face may proceed on separate logical buses so that the controller distinguishes the front and rear tile maps and applies per-face scene mapping without confusion in identifier spaces.

In usage where spectators are close to one face and players or officials are closer to the other, independent content per side 522 may allow a crowd-facing face to host interactive activities, such as a live poll or trivia question, while the field-facing face shows only official game information. The controller may aggregate spectator inputs received via a locally hosted network and update the crowd-facing face accordingly, while leaving the field-facing face unaffected. When the poll completes, synchronized audio-visual effects may be triggered on both faces or on just the crowd-facing face, and timing may be scheduled by the phase coordinator 550 so that animation phases align with driver cycles for visual smoothness.

The heat spreader 566 may cooperate with a thermal sensor array to provide per-zone temperature readings. If a particular quadrant on the front face runs warmer due to sun exposure, the controller may apply a localized brightness cap for that zone while the rear face continues at higher brightness, preserving legibility and thermal safety. In some embodiments, the heat spreader 566 may be bonded to the rear of tiles with thermally conductive adhesive pads that also serve as vibration dampers, and shear-compliant structures may allow small relative motion without debonding under transport loads.

For transport and storage, the dual-sided configuration 510 may include protective corner caps, removable face covers, or a wrap that shields LEDs from abrasion. The overall center of gravity may be aligned with a suspension axis so that the assembly hangs without rotation when supported by a single strap or hook. Optional handles may be integrated into the spine or frame; such handles may be considered optional and are not required for the simplest dual-sided configuration 510.

During manufacturing test, each face within the dual-sided arrays 520 may be exercised independently. Enumeration runs may verify tile IDs, and pattern tests may measure uniformity and detect dead pixels. Phase measurements may be taken with a photodiode on each face so that refresh phase coordination 524 can be adjusted by the phase coordinator 550 to a stored calibration value. If the two faces have different electrical lengths or driver latencies, the calibration may include an offset table indexed by face and by operating mode, and the controller may load the appropriate offsets at start-up.

The dual-sided configuration 510 may be adapted to non-sports contexts such as community information kiosks, pedestrian wayfinding, or manufacturing status boards in which a process cell is served by two aisles. Independent content per side 522 may present aisle-specific instructions, and the phase coordinator 550 may avoid power peaks that could cause nuisance trips in supply-constrained environments. When integrated with the system-level software described elsewhere, the same local onboarding flow may grant different operator roles for each face, and audit logs may record which face received which edits for later review.

In alternative embodiments, the dual-sided arrays 520 may be replaced by a monolithic dual-emissive panel that exposes a logical two-face interface to the controller. In such cases, internal panel timing may be coordinated by the panel's own controller, and the phase coordinator 550 may program the panel to align face timing to the controller's global timebase. The heat spreader 566 may then be implemented as a central backbone integrated into the panel module.

The structures and interactions described for FIG. 5 may therefore provide a concrete realization of a dual-sided, independently addressable, and phase-coordinated display assembly suited to portable deployments. The arrangement may permit continued responsiveness under variable power and radio conditions, may support interactive crowd features on one face while maintaining official score presentations on the other, and may be serviceable in the field by virtue of modular tiles, accessible harnessing, and calibrated timing managed by the phase coordinator 550.

Referring to FIG. 6, an enclosure 610 may house electronics and the reconfigurable modular display while providing structural support, impact resistance, and environmental sealing consistent with outdoor or gymnasium deployment, and the enclosure 610 may be realized as either a rigid shell or a soft-shell variant depending on use case and weight targets. The enclosure 610 may present external mounting features that permit suspension, wall or fence mounting, tripod mounting, or magnetically assisted placement on ferromagnetic structures, and the enclosure 610 may integrate internal rails and bosses for board-level assemblies, wiring harnesses, and service doors. In some embodiments, optional apertures may be provided for tie-downs or safety lanyards; such apertures may be considered optional and may not be required for basic operation of the enclosure 610.

A controller installation 618 may mount a controller board to an internal bracket or standoffs within the enclosure 610 using fasteners, thread-forming screws, or press-fit studs, and the controller installation 618 may position the board to minimize cable lengths to the tile interconnect while preserving airflow paths around heat-generating components. The controller installation 618 may orient the processor and radio modules away from continuous metal surfaces to reduce detuning of antennas and may route a ground strap or chassis bond to reduce electromagnetic emissions. Wire harnesses may be retained by clips or saddles so that service access is clear and so that the controller installation 618 may be removed without disturbing adjacent boards.

A power-management circuit installation 619 may mount a dedicated power PCB within a power bay of the enclosure 610, and the power-management circuit installation 619 may include battery protection, pack balancing, ideal-diode power-path controllers, hold-up capacitors, and connectors for removable battery packs. The power-management circuit installation 619 may provide a regulated DC bus for display tiles and logic rails for the controller, and optional photovoltaic inputs may enter through sealed connectors to a charger stage on the power board. Thermal interface pads or shields may be placed under high-dissipation components so that the power-management circuit installation 619 maintains safe operating temperatures across ambient conditions expected for field deployment.

A soft-shell enclosure variant 620 may be fabricated from coated textiles or laminate fabrics and may include welded, taped, or sealed seams that resist moisture ingress, and the soft-shell enclosure variant 620 may fold for transport and unfold to present the viewing face at the venue. Transparent windows 632 may be aligned with the display tiles so that the LED or LCD surface is optically visible, and the transparent windows 632 may be formed from TPU, PET, or polycarbonate films with abrasion-resistant coatings and UV stabilizers. The soft-shell enclosure variant 620 may include fence straps 634 that route through webbing loops or D-rings and the fence straps 634 may include cam buckles or hook-and-loop closures to tighten the assembly on a fence without tools. An internal stiffener retaining rail 636 may be sewn or riveted into the soft-shell so that it captures an elongated rail or backplane element, and the stiffener retaining rail 636 may prevent panel flex and maintain coplanarity of the display tiles across the face.

Strain-relieved pass-throughs 638 may route cables or harnesses from the interior to the exterior of the soft-shell enclosure variant 620, and the strain-relieved pass-throughs 638 may employ grommets, compression bushings, or molded feed-throughs that maintain fabric integrity and distribute clamping force. Where additional sealing is desired, potting compound 640 may be applied around conductors within the pass-through region, and the potting compound 640 may be a two-part polyurethane or silicone system compatible with jacket materials. An ingress-protection test (spray) 642 may be performed by subjecting the soft-shell assembly to a water-spray pattern across seams and windows at specified flow and distance, and the ingress-protection test (spray) 642 may verify that no visible leakage occurs into the electronics bay for a defined interval.

A rigid enclosure variant 650 may be assembled from injection-molded polymer panels or formed sheet metal panels and may house the same electronics as the soft-shell variant while providing higher stiffness and integrated mounting features, and the rigid enclosure variant 650 may be selected for permanent or semi-permanent installations. Molded-in bosses 652 may be located within the rigid enclosure variant 650 so that controller boards, power boards, and cable guides can be attached without loose nut hardware, and the molded-in bosses 652 may be backed by ribs to distribute load from repeated service operations. Tripod-thread inserts 653 may be embedded brass or stainless inserts that accept standard photographic mounting threads and the tripod-thread inserts 653 may be over-molded into the base or side panels. To establish environmental sealing at panel seams, silicone gaskets 656 may be placed in grooves or on lands to provide compression under screw load, and the silicone gaskets 656 may be selected for durometer and compression set compatible with expected temperature cycles.

A gasketed service door 658 may provide access to the controller bay, battery pack, or removable media, and the gasketed service door 658 may use a continuous seal profile with latch hardware that applies uniform compression around the perimeter. Additional gasketed closures 660 may be used at auxiliary access points and the gasketed closures 660 may employ captive screws to reduce loss during field service. Magnetic attachment plates 662 may be integrated so that the rigid enclosure variant 650 can be temporarily coupled to ferromagnetic structures; the magnetic attachment plates 662 may be recessed or may be removable when magnetic mounting is not desired. Cable glands 664 may provide sealed entries for external leads such as AC adapters, auxiliary sensors, or antenna cables, and the cable glands 664 may be selected with strain relief and jacket diameter range appropriate for the connected cables.

A pressure-decay/leak test 668 may be used to assess the integrity of the rigid enclosure variant 650, and the pressure-decay/leak test 668 may include applying a defined internal pressure or vacuum and measuring decay over a test interval to detect leakage beyond a threshold. The pressure-decay/leak test 668 may be conducted at the manufacturing line and may be repeated after service when panels or doors have been removed. Where the rigid enclosure variant 650 includes transparent regions for displays, an alternate test protocol may be used that focuses on seam regions and penetrations while excluding the display window from differential pressure to avoid stress on the display aperture; such display apertures, when present, may be optional and could also include a sealing bezel around their perimeters.

A battery-management PCB 670 may be disposed within the enclosure 610 and the battery-management PCB 670 may include protection FETs, fuel-gauge ICs, cell-balancing circuits, and temperature sensors, and the battery-management PCB 670 may interface to removable battery packs via keyed connectors located within the power bay. The battery-management PCB 670 may communicate with the controller through an I²C or SPI link and may provide state-of-charge, cycle count, and estimate of remaining runtime so that the controller can present the remaining-runtime estimate in the control interface. When hot-swap capability is provided, the battery-management PCB 670 may coordinate pre-charge and power-path handover so that ride-through on the display rails is maintained during pack change.

An ambient-light sensor 656A may be mounted on or within the enclosure 610 to measure incident illumination and the ambient-light sensor 656A may provide a signal to the controller that enables brightness adjustment of the display according to a modulation scheme that reduces visible artifacts, as described elsewhere. In some embodiments, the ambient-light sensor 656A may be located behind a small window or light pipe integrated into the rigid enclosure variant 650 or located under a clear portion of the soft-shell enclosure variant 620, and the ambient-light sensor 656A may include on-board filters to approximate photopic response.

The controller installation 618 and the power-management circuit installation 619 may be positioned within the enclosure 610 to maintain short routing of the tile interconnect and to support cable management that complies with bend radius and strain limits. In both variants, the enclosure 610 may include internal channels or clamps that separate low-voltage data harnesses from higher-current power runs to reduce crosstalk, and the enclosure 610 may present tie-points for ferrite cores where needed to meet electromagnetic compatibility policies.

In the soft-shell enclosure variant 620, the transparent windows 632 may be attached with RF welding or adhesive bonding and the transparent windows 632 may be cut to fit the tile grid with sufficient overlap onto the fabric to maintain seal integrity. The fence straps 634 may be bar-tacked into the body material to reach the structural stiffener retaining rail 636 so that loads are carried into the rail rather than into the window seams. The strain-relieved pass-throughs 638 may be placed near the hinge or fold axis so that repeated opening and closing does not over-bend the harness, and the potting compound 640 may be applied to encapsulate conductors where they exit the interior to limit moisture ingress through capillary action.

In the rigid enclosure variant 650, the molded-in bosses 652 may be co-located with ribs that align with the silicone gaskets 656 so that clamp forces produce even compression, and the gasketed service door 658 may be placed on the rear or side wall to provide tool-accessible service while keeping the display face unobstructed. The magnetic attachment plates 662 may be spaced such that torque from a cantilevered mount is counteracted, and the cable glands 664 may be located low on the side wall to create a drip loop for outdoor use.

For manufacturing and field qualification, the ingress-protection test (spray) 642 may be used primarily for the soft-shell enclosure variant 620 to validate seam integrity, while the pressure-decay/leak test 668 may be used primarily for the rigid enclosure variant 650 to validate gasket and joint integrity. When both tests are employed in a single product family, acceptance criteria may be documented per material system so that consistent sealing performance is achieved across variants. In some embodiments, an optional desiccant pouch or conformal coating may be added inside the enclosure 610 to mitigate condensation in humid environments; such measures may be optional and may not be required in all deployments.

The structures shown in FIG. 6 may integrate with the controller's local wireless connectivity and diagnostic routines described elsewhere by providing access points for antennas, service doors for pairing screens on removable media, and mounting planes that keep the display tile plane flat in both soft-shell and rigid embodiments. The arrangement of the controller installation 618, the power-management circuit installation 619, and the battery-management PCB 670 within the enclosure 610 may permit service in the field with minimal tools, while the ambient-light sensor 656A and the sealing and mounting features (including the transparent windows 632, fence straps 634, stiffener retaining rail 636, strain-relieved pass-throughs 638, potting compound 640, silicone gaskets 656, gasketed service door 658, gasketed closures 660, magnetic attachment plates 662, and cable glands 664) may support consistent visual performance and environmental resilience across varied venues.

In some embodiments, dimensional targets for the enclosure 610 may include an overall wall thickness between approximately 1.8 mm and 3.2 mm for molded polymers or a sheet thickness between approximately 0.9 mm and 2.0 mm for formed metals, and ribs may be spaced at a pitch selected to meet stiffness goals derived from simple beam deflection approximations under expected suspension loads; for a uniformly distributed load w across a span L, the mid-span deflection may be estimated by δ≈5 wL\hat{ }4/(384 EI), where E is material modulus and I is the second moment of area of the ribbed panel cross-section. The controller installation 618 may position the processor away from continuous metallic surfaces by a setback distance in the range of 10-25 mm so that integrated antennas couple to free space rather than to the chassis, and a ground reference strap may be bonded from board ground to the enclosure 610 at a single point to reduce ground loops while providing an electrostatic discharge path.

The power-management circuit installation 619 may include current-sense amplifiers that report instantaneous and averaged current to the controller so that brightness and animation density may be modulated during low-state-of-charge conditions reported by the battery-management PCB 670. The battery-management PCB 670 may implement cell balancing using passive bleed resistors switched under microcontroller supervision or integrated balancer ICs; balancing may be inhibited when the temperature reported by pack thermistors exceeds a setpoint. To support hot-swap, a pre-charge network may charge the bus-side capacitors prior to closing a main ideal-diode path, which may reduce inrush; pre-charge time constants may be set according to τ=RC, where C is effective downstream capacitance and R is pre-charge resistance, and τ may be selected so that the ride-through budget on the display rails remains below the drop-out window tolerated by tile drivers.

In the soft-shell enclosure variant 620, fabric selections may include polyester with TPU coating (e.g., 600D), nylon with PU coating (e.g., 420D), or laminates with woven face fabric and waterproof membrane. Seam construction may use radio-frequency welding or hot-air taped seams; seam lap width may be chosen in the range of 8-20 mm to maintain seal strength under strap tension transmitted by fence straps 634. Transparent windows 632 may be flat or slightly domed; haze values may be below 2% for readability at distance, and surface hardness coatings may be specified by pencil hardness (e.g., ≥3H) for scratch resistance. The stiffener retaining rail 636 may be an aluminum bar or composite plank that distributes loads from fence straps 634 into the tile plane; fasteners may pass through grommeted eyelets to the rail, and washers may be used to avoid localized fabric creep.

Strain-relieved pass-throughs 638 may be positioned along a neutral axis of fold so that routing does not exceed a bend radius recommended by cable suppliers, such as ten times outer diameter for repeated cycles. Potting compound 640 may occupy the annular region between cable jacket and pass-through bushing to inhibit capillary tracks; potting chemistries may be selected for adhesion to polyamides and PVC jackets and for flexibility so that strain transfer is mitigated. For ingress-protection test (spray) 642, spray nozzles may be arranged to deliver flow at 10-15 L/min at a standoff of 2-3 m in a sweep pattern across seams and transparent windows 632 for test durations between 3 and 10 minutes; acceptance may be defined by absence of water droplets within the electronics bay and by continuity tests on moisture indicators placed adjacent to pass-throughs.

In the rigid enclosure variant 650, material selections may include PC/ABS for impact resistance, glass-filled nylon for stiffness with weight savings, or powder-coated aluminum for thermal robustness. Molded-in bosses 652 may be designed with thread-forming screws and pilot diameters calibrated to achieve recommended thread engagement while avoiding crack initiation. Tripod-thread inserts 653 may be heat-staked or ultrasonically embedded; when used for overhead loads, inserts 653 may be backed by gussets that carry tensile forces into the panel. Silicone gaskets 656 at panel joints may be designed for 20-35% compression when assembled; bead geometry may be D-profile or hollow-core to improve resilience, and joint designs may include anti-extrusion lands at corners. A gasketed service door 658 may employ a continuous molded seal with latch points at edge midpoints to generate even compression; hinge designs may include lift-off pin or butt hinge, and the path of the harness through the hinge region may include a service loop to preclude conductor stress. Gasketed closures 660 may be used at auxiliary doors or knock-out panels and may use captive hardware for field convenience.

Magnetic attachment plates 662 may be formed from steel plates bonded within pockets and paired with permanent magnets in a mating bracket or, conversely, magnets may be embedded within the enclosure 650 and coupled to ferromagnetic structures in the field. Pull-off force may be tuned by magnet grade and standoff; a user may slide the unit laterally to ease removal to avoid detachment shocks. Cable glands 664 may be compression-style with an elastomeric seal; IP ratings may be dependent on torque applied at assembly and on jacket diameter selection, and locknuts may be used inside the enclosure 610 for retention. Pressure-decay/leak test 668 parameters may include pressurization to a small over-pressure (e.g., 2-5 kPa) followed by a hold interval where a sensor logs decay; pass criteria may be expressed as dP/dt below a threshold (e.g., <0.2 kPa/min), and tests may be performed at ambient temperature with unit sealed except for a test port.

The ambient-light sensor 656A may be oriented so that direct incident sunlight does not saturate the detector; a small translucent baffle may be added to reduce specular glare while preserving diffuse field measurement. The controller software may apply a brightness mapping function Lout=f(Lambient) where f may be a piecewise-linear or logarithmic curve; hysteresis may be included to avoid flicker in transitional lighting. Sampling intervals may be adjusted by time-of-day or motion events; in a gymnasium, integration times may be increased to average out flicker from mains-frequency lighting. The brightness control loop may communicate with the rendering stack to adjust per-channel gamma tables such that apparent contrast remains near constant while absolute luminance varies.

In a typical interaction, the controller installation 618 may bootstrap radios, run local onboarding, and expose a web interface where an operator selects enclosure type (soft vs. rigid) so that software enables appropriate environmental monitoring, such as moisture indicator polling in soft-shell assemblies or pressure sensor checks in rigid assemblies. The battery-management PCB 670 may publish telemetry through the power-management circuit installation 619 to the controller for logging and for user-visible runtime estimates. When a cable gland 664 is opened for adding an accessory lead, a diagnostic wizard may prompt the user to re-run a local spray test or sensor check to confirm that sealing remains within specification.

Alternate configurations may include a rigid enclosure variant 650 with an internal sub-frame that accepts both tile and monolithic displays; quick-change rails may allow the display face to be swapped without disturbing the controller installation 618 or the power-management circuit installation 619. The soft-shell enclosure variant 620 may be offered with removable transparent windows 632 that attach with zippers or hook-and-loop; a spare window may be carried for field replacement. Fence straps 634 may be replaced by cam-buckle straps in wind-exposed venues; a safety tether through an optional aperture may be added for fall protection. Magnetic attachment plates 662 may be omitted where ferromagnetic mounting is not desired; tripod-thread inserts 653 may then serve as the primary rigid mount.

Software may include firmware modules that abstract sensor inputs from the ambient-light sensor 656A, pressure sensors associated with pressure-decay/leak test 668, and moisture probes near strain-relieved pass-throughs 638. A “seal-health” process may compute a composite status from these sensors and may present advisory icons on the user interface; when a threshold is crossed, brightness may be limited or a service recommendation may be shown. The adapter stack may include a system health feed so that fleet dashboards may display enclosure status aggregated across units. Logging may timestamp ingress-protection test (spray) 642 events and pressure-decay/leak test 668 runs together with outcomes to provide traceability.

From an engineering perspective, thermal management may be considered jointly with sealing, since higher sealing reduces convective exchange. For the rigid enclosure variant 650, vent-less operation may be supported by conduction through the enclosure walls and by heat spreading into rails and stiffeners; power budgets may be configured so that temperature rise remains within device limits across ambient range. For the soft-shell enclosure variant 620, controlled vent paths beneath flaps may be included without compromising spray performance; these features may be optional and may be omitted in embodiments seeking higher ingress protection.

Practical deployments may include open-air fields, damp grass, or dusty infields; the cable glands 664 and gasketed service door 658 may be selected to resist particulate ingress. In winter use, gloves may reduce dexterity; latch hardware on service doors and closures 660 may be sized for gloved operation. In rental fleets, visual inspection points may be co-located near molded-in bosses 652 so that cracks or thread wear can be identified quickly. For school deployments, magnetic attachment plates 662 may facilitate mounting on bleacher structures where straps are not permitted.

The combination of features disclosed for FIG. 6 may support claim sets directed to environmental sealing, modular mechanical systems, and sensor-assisted operations. For instance, an independent claim may be directed to an enclosure system including the ambient-light sensor 656A and the seal-health processing that modulates brightness, with dependent claims capturing pressure-decay/leak test 668 instrumentation, ingress-protection test (spray) 642 procedures, and potting compound 640 configurations at pass-throughs 638. Another claim path may emphasize interchangeable soft-shell and rigid variants using a common controller installation 618 and power-management circuit installation 619, and a further path may protect mixed-mount options through tripod-thread inserts 653 and magnetic attachment plates 662.

In healthcare-adjacent events such as temporary immunization clinics, the soft-shell enclosure variant 620 may be sanitized using diluted cleaning agents compatible with transparent windows 632 and fabric coatings; the system may be used to display queue numbers on one side and informational messages on the other. For manufacturing lines, the rigid enclosure variant 650 may be mounted above a cell using tripod-thread inserts 653 and magnetic attachment plates 662, with runtime and maintenance intervals computed from the battery-management PCB 670 telemetry.

In some embodiments, a forthcoming figure may depict an electrical block diagram of environmental sensors and seal-health computation tied to the ambient-light sensor 656A, pressure-decay/leak test 668 transducer, and moisture probes proximate the strain-relieved pass-throughs 638, and such a figure may show message routing to a cloud fleet monitor as an example.

In another example, a forthcoming figure may present a manufacturing-line test flow that sequences ingress-protection test (spray) 642, pressure-decay/leak test 668, controller installation 618 firmware update, and battery-management PCB 670 calibration, where each step may be logged locally and optionally uploaded when connectivity is available.

In some embodiments, operational feedback may be used to refine thresholds or behaviors over time. For example, the controller may maintain a moving average of ambient-light sensor 656A readings and associated user-selected brightness overrides, and a configuration-update process may adjust the brightness mapping function after sufficient evidence is collected, subject to administrator approval. A similar approach may be applied to seal-health thresholds by correlating moisture sensor events with ingress-protection test (spray) 642 logs and pressure-decay/leak test 668 outcomes.

It shall be noted that the features described with respect to the enclosure 610 and its variants may be used across diverse industry domains, and that options such as transparent windows 632, fence straps 634, and magnetic attachment plates 662 may be mixed to suit particular deployment practices. The structures, sensors, and processes associated with FIG. 6 may thus provide robust enablement for environmental sealing, mounting, and power-aware operation, while remaining adaptable to alternative materials, dimensions, and assembly sequences that a person of ordinary skill could implement to achieve substantially similar results.

Referring to FIG. 7, a scene configuration interface 710 may provide a declarative layout editor through which an operator or designer may define visual arrangements, styles, and behaviors without modifying low-level rendering code. The scene configuration interface 710 may present a canvas with drag-and-drop widgets (e.g., team blocks, score digits, period clocks, icons, banners, sponsor regions) and may expose property panels for sizes, fonts, color palettes, alignment rules, animation presets, and conditional visibility; a raw editor pane may permit direct editing of a machine-readable representation such as JSON or a lightweight domain-specific language. In some embodiments, the scene configuration interface 710 may be accessible from a local web page hosted by the controller, may be protected by role-based access, and may preview the layout on a simulated grid approximating the currently detected tile map so that edges and seams may be considered during design. The scene configuration interface 710 may store and retrieve templates for different sports or event types and may include accessibility presets that increase glyph thickness and contrast for distance readability.

Declarative layout data 720 may be produced by the scene configuration interface 710 and may describe a scene as a tree of elements with typed fields for geometry, z-order, styling, data bindings, and behaviors. The declarative layout data 720 may include, by way of example, a root object with width and height in logical units, one or more containers describing grid or flex layouts, and leaf nodes such as text, numeric counters, icons, or vector paths. Data bindings may reference symbolic fields of an internal schema (e.g., home. name, away. score, inning. index, strikes. count) or transient variables (e.g., poll. votes[A], timer. remaining). Constraints may express alignment and sizing, such as “score.right=container.right−8u,” “team.left=container.left+8u,” or “period.centerX=container.centerX,” where u denotes a logical grid unit that may scale with the physical layout. The declarative layout data 720 may also define animation blocks, such as “onScoreChange: bounce(duration=240 ms, amplitude=0.8)” or “onPollResult: confetti(duration=1.5 s, density=low),” and may attach timing hints that the renderer respects when frame time budgets allow.

A render pipeline compile step 730 may process the declarative layout data 720 and may produce a scene graph with drawable nodes and resolved dependencies. The render pipeline compile step 730 may validate schema references, resolve style inheritance and theme tokens, compute absolute transforms from constraints, and pre-rasterize static glyphs or sprites into atlases to minimize per-frame overhead. In some implementations, the render pipeline compile step 730 may convert text blocks to glyph runs with kerning and line breaks resolved; numeric counters may be compiled to digit slots that accept fast updates; vector elements may be tesselated to triangle meshes; and icon references may be mapped to sub-textures in a shared atlas. When the declarative layout data 720 references conditional visibility, the render pipeline compile step 730 may generate switch nodes that enable or disable subtrees as a function of data predicates.

A scene graph 740 may represent the compiled, runtime data structure used by the renderer to determine what to draw and in what order. The scene graph 740 may be organized into layers with optional compositing modes and may include child nodes corresponding to semantic elements, such as team identifiers 742 representing text labels or logos, score values 744 representing numeric counters for home and away teams, and a period indicator 746 representing inning, period, or time fields. Each node may include properties for transform, opacity, color, font or sprite key, and animation state; a dirty flag may identify nodes that require redraw. A node's content may be bound to an internal schema field or an aggregated spectator variable, and updates from the controller may propagate through bindings to mark dependent nodes dirty. The scene graph 740 may maintain an ordering that respects z-index and stable stacking so that overlapping animations and banners render predictably.

A scene-to-layout mapper 752 may convert logical coordinates and node geometry from the scene graph 740 to physical pixel locations on the reconfigurable modular display detected by the layout subsystem. The scene-to-layout mapper 752 may accept the currently active tile map and may compute per-tile spans intersected by each node's bounding boxes so that draw calls may be segmented and routed to appropriate tiles. When the physical layout changes (e.g., a tile added or removed), the scene-to-layout mapper 752 may receive a reflow signal and recompute transforms, including scaling if the operator selected “fit” behavior and anchoring if the operator selected “pin to edge” behavior. In a dual-sided configuration, the scene-to-layout mapper 752 may maintain independent mappings for the two faces and may apply per-face transforms if the faces differ in resolution or aspect. When a monolithic panel exposes a logical grid, the scene-to-layout mapper 752 may map nodes to virtual tiles that the panel driver further resolves internally.

A modulation scheme (video artifacts reduction) 754 may represent a set of drive parameters and clocking patterns used by the renderer and driver to reduce visible artifacts in camera recordings or under particular lighting conditions. The modulation scheme 754 may select a pulse-width modulation strategy (e.g., bit-plane scheduling, center-aligned PWM) and may adjust the bit-plane ordering or splitting to reduce long dark intervals that interact with rolling-shutter sampling in phones. The modulation scheme 754 may further apply per-digit phase staggering for large numeric fields, so that not all digit segments update in the same sub-frame, and may limit maximum instantaneous current by distributing high-energy bit-planes across time and tiles. Under gymnasium lighting, the modulation scheme 754 may shift refresh away from mains frequencies to reduce banding in recorded media. The modulation scheme 754 may be dynamically selected by the controller based on measured frame time, brightness targets derived from an ambient-light sensor described elsewhere, and operator preferences for “broadcast-friendly” or “battery-friendly” modes.

The scene configuration interface 710 may include a live preview mode where the render pipeline compile step 730 and the scene-to-layout mapper 752 are executed in a sandbox on the operator device or on the controller with results streamed back, enabling iterative adjustment of constraints and styles. A syntax checker may highlight missing schema bindings or conflicting anchors (e.g., two opposing pins both fixed), and a layout inspector may visualize bounding boxes and tile seams so that text or digits may be kept within single tiles when desired. Profiles may be saved as templates and applied across fields with different physical displays; in that case, the scene-to-layout mapper 752 may scale and anchor per the template's fit rules, and the render pipeline compile step 730 may re-rasterize fonts at the appropriate sizes.

When game-state data is received through the controller's programmatic interface, the update subsystem may map fields to the internal schema and propagate changes to bound scene graph 740 nodes. Team identifiers 742 may update when an operator edits names or loads a roster; score values 744 may update on play events; the period indicator 746 may step according to time or inning changes from an adapter. A conflict-resolution policy may determine whether a manually set value temporarily overrides an inbound feed; in such cases, the scene graph 740 may display the manual value until the window expires or the operator clears the override. For interactive activities, aggregation results may be bound to nodes representing bar graphs or text overlays, and animation triggers defined in the declarative layout data 720 may execute when thresholds are met.

The scene-to-layout mapper 752 may consider pixel density differences across tiles and may apply per-tile gamma or calibration curves if provided by the hardware layer. When a tile is missing or disabled, the scene-to-layout mapper 752 may clip draw calls and may adjust surrounding anchors to avoid partially drawn digits. An operator may select a resilience mode in the scene configuration interface 710 whereby digits split across two tiles are replaced with a condensed single-tile glyph set if a seam risk is detected. For numeric counters, the render pipeline compile step 730 may compile multiple glyph sets (e.g., condensed, wide) and the scene-to-layout mapper 752 may pick an appropriate set at runtime depending on the current layout.

In some embodiments, the declarative layout data 720 may specify conditional content per role or per audience so that, in a dual-sided unit, one face shows only official fields and the other face shows interactive prompts. The scene configuration interface 710 may permit operators to preview per-face views and to assign transition schedules, such as rotating sponsor banners between innings. When the controller enforces a command-to-render latency target, the render pipeline compile step 730 may reduce animation complexity by using cached sprite sheets instead of procedural effects and may shrink atlases to stay within memory budgets.

The modulation scheme 754 may be complemented by color management in which perceived luminance is matched across hues using a color-appearance model approximated for the display's spectral response. The scene configuration interface 710 may offer palette presets that maintain legibility under daylight or gymnasium lighting, with contrast ratios computed for sample backgrounds to meet accessibility thresholds. In animation code paths, the modulation scheme 754 may provide “safe windows” where high-contrast transitions occur close to frame boundaries to minimize interpolation artifacts under rolling shutter.

In practice, operators may create a baseball template with team identifiers 742 positioned at left and right, score values 744 below the labels, and a period indicator 746 for inning centered; the scene configuration interface 710 may allow adding a base-occupancy icon, pitch count, and sponsorship banner. The same template may be repurposed for soccer by renaming fields and switching the period indicator 746 to a clock; the render pipeline compile step 730 may re-compute text metrics and the scene-to-layout mapper 752 may resize and anchor the banner. If a tile is removed due to damage, the mapper may re-layout to preserve whole digits and move the banner to a smaller region.

For auditing and diagnostics, the scene configuration interface 710 may maintain a version history for declarative layout data 720 with timestamps and user IDs; the render pipeline compile step 730 may record compile warnings (e.g., “glyph atlas reached 90% capacity”) and the scene-to-layout mapper 752 may log reflows and seam warnings. The modulation scheme 754 selections and parameters may also be logged so that, if a recording shows banding, operators can correlate conditions and adjust presets. Where an external admin service is present, template bundles may be synchronized across devices so that events use consistent branding.

In some implementations, the declarative layout data 720 may support computed fields via small expressions (e.g., “displayScore=home.score+‘−’+away.score”), with a restricted expression engine to maintain safety. The render pipeline compile step 730 may evaluate these expressions during updates and may cache results to avoid unnecessary redraw. For clocks, the scene graph 740 may include a timer node that decrements by a scheduler tick; if an external time source is available, drift correction may be applied using small adjustments to avoid visual jumps.

The modulation scheme 754 may expose user-facing controls such as “reduce artifacts for filming,” which internally configures bit-plane order, PWM frequency, and phase offsets to a pre-tuned profile for common phone camera frame rates. For outdoor sunlit conditions, a “high-nits” profile may shift emphasis to higher duty cycles with less intermediate luminance resolution. The scene configuration interface 710 may present a simulation panel that approximates how a phone camera would record the display under selected modulation profiles, enabling operators to choose an appropriate setting before events.

In dual-sided assemblies, the scene-to-layout mapper 752 may cooperate with a phase coordinator described in another figure to stagger high-energy updates across faces. The declarative layout data 720 may include per-face sections or references so that the render pipeline compile step 730 compiles two scene graphs 740 with shared assets to reduce memory. When independent content is presented per face, the modulation scheme 754 parameters may be tuned individually to match face-specific pixel densities or brightness targets.

The scene configuration interface 710 may optionally export a compact binary representation of declarative layout data 720 for faster load on resource-constrained controllers. The render pipeline compile step 730 may then operate on the binary form and may skip parsing overhead. For fleets, centralized tooling may validate declarative layout data 720 against a known schema and may sign bundles to prevent tampering; devices may verify signatures before loading.

In sum, FIG. 7 depicts an example pipeline in which a scene configuration interface 710 emits declarative layout data 720 that a render pipeline compile step 730 compiles to a scene graph 740 containing nodes such as team identifiers 742, score values 744, and a period indicator 746; a scene-to-layout mapper 752 maps the scene to the current physical layout; and a modulation scheme 754 sets drive parameters to reduce visible artifacts while meeting performance and power objectives. This arrangement may allow non-technical operators to configure rich, responsive scoreboard presentations that adapt to hardware changes and venue conditions while maintaining low latency and visual clarity.

Referring to FIG. 8, which illustrates networking and interactivity for a portable scoreboard controller, a locally hosted network may be provided by local wireless connectivity 810 that is served by a local wireless connectivity interface 812 resident within the controller hardware. In certain aspects, local wireless connectivity 810 may advertise a service set identifier and accept multiple concurrent client associations without reliance on external infrastructure, and the local wireless connectivity interface 812 may include one or more radio transceivers, baseband processors, and antenna paths integrated into a system-on-chip or modular radio card. In various aspects, the controller may expose a control interface UI 876 to connected operator devices while keeping spectator connections logically segregated as described below. In some aspects, traffic partitioning 852 may implement logical separation of operator flows and spectator flows, and role partitioning logic 854 may enforce access control policies that assign permissions to different user groups.

In certain aspects, an onboarding pathway may begin by rendering a machine-readable pairing code 860 on the scoreboard display, where the pairing code may be a scannable symbol, and an ephemeral token 862 may be encoded to carry a time-bounded credential. In some aspects, a local onboarding flow 864 may respond to a scan by presenting a captive portal or web screen that issues role-based session credentials 866 to operator devices and session tokens 868 to all authenticated clients. In various aspects, security parameters for access control 848 may define cipher suites, authentication modes, and session lifetimes, and access control parameters 850 may include device-class rules and permission scopes associated with operator and spectator roles. In other aspects, audit logs 872 may persist role-scoped operations such as score edits, layout changes, and adapter configuration updates to permit later review and manufacturing end-of-line verification.

In certain aspects, data transport between the controller and connected clients may utilize a low-latency message channel 840 such as a persistent bidirectional stream that carries control commands and display updates. In various aspects, a command-to-render latency bound 842 may be maintained by the controller render pipeline by prioritizing score updates and acknowledging operator actions in a deterministic order. In some aspects, these timing characteristics may be recorded in diagnostic events included within audit logs 872 to support field service and latency acceptance checks.

In various aspects, local radio conditions may be monitored by an interference conditions detector 844 that samples the channel environment, and operating channel selection logic 846 may select or reselect an operating channel responsive to measured interference. In some aspects, the local wireless connectivity interface 812 may coordinate a quiet-period transition when reassigning channels, and local wireless connectivity 810 may broadcast updated parameters to already associated devices to maintain session continuity.

In certain aspects, the controller may communicate with a remote network endpoint through a programmatic interface 830 to obtain game-state data, standings, or other event information. In some aspects, programmatic interface adapters 880 may provide service-specific connectors for a plurality of external scoring services, and a normalization transformer 882 may convert service payloads into a common internal schema for the controller. In various aspects, remote sync via secure transport 834 may be used to synchronize a subset of state to an external service while maintaining local rendering when remote connectivity is intermittent, and the controller may retain an offline-first posture for scoreboard responsiveness.. The future figure may show an example controller software stack with programmatic interface adapters 880, normalization transformer 882, and conflict-resolution policies applied to the internal schema.

In some aspects, the controller may execute an interactive activity engine 886 that provides audience-facing activities including polls, quizzes, or votes. In various aspects, spectator inputs 888 may be received from client devices connected via local wireless connectivity 810, and per-device rate limits 889 may limit the volume of submitted inputs per time window. In certain aspects, duplicate-input suppression 891 may filter repeated responses from an identical session and reduce bias, and an aggregation engine 894 may compute activity results over a defined window. In some aspects, a threshold evaluation engine 896 may compare aggregated values to a preconfigured threshold and, upon satisfaction of the threshold, cause the controller to select and present a corresponding audiovisual effect or display transition.. The future figure may depict an example onboarding and interaction flow illustrating machine-readable pairing code 860, ephemeral token 862, role-based session credentials 866, session tokens 868, spectator inputs 888, and aggregation engine 894.

In various aspects, the control interface UI 876 presented to operators may include a layout view, team fields, period indicators, and optional runtime estimates. In certain aspects, the control interface UI 876 may issue commands over the low-latency message channel 840 such that operator edits are reflected on the scoreboard within the command-to-render latency bound 842. In some aspects, conflict resolution between operator edits and remote programmatic updates may be performed according to deterministic rules that consult timestamps or field-level priorities, and resolution outcomes may be recorded in audit logs 872.

In certain aspects, traffic partitioning 852 may be implemented through logical network separation, application-level namespaces, or tagged message channels that isolate operator flows from spectator flows. In various aspects, role partitioning logic 854 may be a policy engine that validates role-scoped actions and prevents spectators from invoking control interface UI 876 functions reserved for operators. In some aspects, these controls may permit concurrent spectator participation while preserving operator authority over the scoreboard scene graph and timing.

In various aspects, the controller may dynamically adjust network parameters based on interference conditions detector 844 readings and may store selection outcomes and operating channel selection logic 846 decisions in audit logs 872 to support compliance and field diagnostics. In certain aspects, local wireless connectivity 810 may be implemented in access-point, peer-to-peer, or mixed modes, and the local wireless connectivity interface 812 may manage beacons, association flows, and security handshakes coherent with security parameters for access control 848. In some aspects, the access control parameters 850 may include token lifetimes for ephemeral token 862, issuance rules for role-based session credentials 866, and cryptographic signature metadata for session tokens 868.

In certain aspects, the programmatic interface 830 path may use programmatic interface adapters 880 to fetch game-state items and pass them through normalization transformer 882 before use in the render pipeline, and remote sync via secure transport 834 may export a subset of finalized fields to a remote service as needed. In various aspects, the controller may maintain a local cache and retry queue such that normal operation persists during remote outages. In some aspects, the controller may log adapter responses and transformation results in audit logs 872 to aid post-event analysis or quality review.

In various aspects, the interactive activity engine 886 may publish a scene for activity prompts and may receive spectator inputs 888 routed through the low-latency message channel 840 or a web endpoint exposed by local wireless connectivity 810. In certain aspects, per-device rate limits 889 and duplicate-input suppression 891 may be tunable, and the aggregation engine 894 may output an interim or final result value to the controller for rendering. In some aspects, the threshold evaluation engine 896 may trigger a celebration sequence or a mode switch when activity conditions are met, and any such event may be recorded in audit logs 872.

In certain aspects, an end-of-line or deployment diagnostic may confirm that the command-to-render latency bound 842 falls within a target range under typical network load, and that the onboarding sequence using machine-readable pairing code 860 and ephemeral token 862 completes within a target interval. In various aspects, these diagnostics may be accessed through the control interface UI 876 and stored via audit logs 872 for subsequent analysis.

In some aspects, the architecture depicted in FIG. 8 may be paired with dual-sided or single-sided display configurations; the networking and interactivity elements remain applicable independent of display topology, and the low-latency message channel 840 and command-to-render latency bound 842 targets may be maintained across both configurations. In many aspects, materials and physical placement for antennas within the local wireless connectivity interface 812 may be selected to provide adequate link budgets when the enclosure is fence-mounted or tripod-mounted, and access control parameters 850 may be tuned to the expected operator and spectator densities at a venue.

In certain aspects, integration points illustrated by programmatic interface 830 and remote sync via secure transport 834 may be applied to live data feeds, rehearsal datasets, or cached game-state sources, enabling flexible operation in both connected and offline environments. The future figure may provide a detailed power-path schematic and interactions between low-power subsystems and networking subsystems during low-power standby or battery hot-swap scenarios, with audit hooks in audit logs 872 and reconnection behavior governed by access control parameters 850 and security parameters for access control 848.

In various aspects, the described elements of FIG. 8 may be implemented in software, firmware, and hardware within the controller, and may be configured to work together to provide responsive control for the modular display while isolating operator and spectator functions. In some aspects, the presented structure may scale to multiple portable units in proximity by coordinating operating channel selection logic 846 decisions via an administrative policy or a local heuristic fed by interference conditions detector 844 measurements.

In various aspects, quantitative targets for the command-to-render latency bound 842 may be expressed as a range that accounts for network load and display update complexity, such as 30-150 ms end-to-end as measured from operator action at the control interface UI 876 to a visible pixel change on the modular display, though other ranges may be used depending on transport and rendering strategies. In certain aspects, the low-latency message channel 840 may use a persistent streaming transport with application-level frames including a monotonic sequence number, a coarse timestamp, and an optional hash of the payload to aid integrity checks. In some aspects, message priority may be applied such that score updates and safety-critical UI notices are transmitted ahead of animations or spectator interactivity payloads, and head-of-line blocking may be reduced by permitting parallel streams or by sharding scene updates across multiple frames. In various aspects, clock discipline for latency measurements may be provided by a local time source in the controller, with optional network time synchronization that may rely on a lightweight protocol or a direct operator-device echo mechanism that measures round-trip time and calculates one-way delay under a symmetric path assumption. In some aspects, jitter buffering may be applied on the receiver to smooth bursty updates while preserving responsiveness, and queue depth metrics may be written to audit logs 872 for post-event analysis. In certain aspects, a bounded exponential backoff may be applied for reconnect logic on the low-latency message channel 840, where the backoff window may be reset upon a successful keepalive exchange. In many aspects, security parameters for access control 848 may specify cipher negotiation and token binding semantics for the control path, while access control parameters 850 may include per-role maximum message rates to avoid congestion events attributable to simultaneous editing.

In certain aspects, programmatic interface 830 transactions may be defined over a structured payload format such as a tree of key-value pairs that include game-state fields (e.g., team identifiers, period indicator, score values, clock or count fields) and provenance metadata (e.g., service identifier, service timestamp, payload hash), and normalization transformer 882 may map the service-specific keys into an internal schema with canonical field names, types, and units. In some aspects, normalization may include type coercion (string to integer for score values), range clamping for counters, timezone normalization for timestamps, and unit conversion for timers expressed as seconds versus mm: ss representations. In various aspects, a conflict resolution policy may evaluate record versions based on source timestamps and field-level priorities, and ties may be broken using deterministic ordering on (service identifier, sequence number) to preserve stable outcomes. In certain aspects, adapter-level caches maintained by programmatic interface adapters 880 may employ a write-through policy to ensure that normalized records are locally available in offline-first operation, while a retry queue may use a capped exponential schedule with jitter to avoid persistent synchronization peaks when remote connectivity returns. In some aspects, remote sync via secure transport 834 may be implemented over a cryptographic channel with session resumption and certificate validation; certificate pinning may be optionally employed in controlled deployments. In various aspects, adapter health, average latency, error codes, and payload sizes may be periodically sampled and recorded in audit logs 872, and thresholds may be configured to trigger a temporary promotion of operator edits when a service is marked as degraded.

In various aspects, multi-unit deployments may use a distributed coordination routine in which each unit periodically publishes a beacon on a low-duty-cycle management interval indicating current channel, bandwidth, and measured interference summary from interference conditions detector 844, and operating channel selection logic 846 may choose the least occupied channel within a permitted band using a scoring function that weights co-channel occupancy, adjacent-channel overlap, and observed retry rates. In certain aspects, hysteresis may be applied to avoid oscillation when two nearby units observe similar channel scores, and a backoff window may be randomized when a channel switch is contemplated to reduce simultaneous retunes. In some aspects, local wireless connectivity 810 may be configured in either access-point mode or peer-to-peer mode, and the local wireless connectivity interface 812 may adjust beacon intervals, transmit power, and bandwidth according to venue size and expected client density. In various aspects, antenna placement within the enclosure may use a planar inverted-F element adhered to a radome region or a coax-fed monopole with clearance to ground planes, and radiation efficiency may be characterized under fence-mount and tripod-mount conditions to account for nearby metal structures that influence the near field. In certain aspects, test reports for radiated performance may be recorded at manufacturing to guide field placement recommendations.

In some aspects, machine-readable pairing code 860 may encode ephemeral token 862 using a compact alphanumeric scheme with checksum, and a session bootstrap document may be retrieved over local wireless connectivity 810 that contains the service URL, a one-time nonce, and a public parameter required to establish session tokens 868. In various aspects, the local onboarding flow 864 may provide a captive portal that requests minimal metadata from an operator device, such as a display name and role selection, and role-based session credentials 866 may be minted by the controller and signed to prevent tampering. In certain aspects, token lifetimes and refresh behavior may be configured according to access control parameters 850, and a sliding window for token renewal may be applied to maintain sessions across channel changes. In some aspects, audit logs 872 may record onboarding events, including QR scan timestamps and client identifiers, and may redact personally identifying data by hashing or truncating fields.

In various aspects, interactive activity engine 886 may render a state machine for activity prompts, countdown windows, and result presentation. In certain aspects, spectator inputs 888 may be validated against session tokens 868 and then passed through per-device rate limits 889 that may be implemented using a token-bucket algorithm with configurable fill rate and bucket capacity. In some aspects, duplicate-input suppression 891 may apply deduplication using a rolling hash of the client identifier, prompt identifier, and selection value, and aggregation engine 894 may compute totals in a sliding window using fixed-interval buckets whose width may be selected to balance responsiveness against statistical smoothing. In various aspects, threshold evaluation engine 896 may support comparators (>, ≥, <, ≤), relative thresholds (e.g., a percentage of total inputs), and compound predicates (e.g., value A≥τ1 AND value B≤τ2), and upon a satisfied predicate may emit an event consumed by the render pipeline. In certain aspects, control interface UI 876 may display a compact monitor of current participation rates and may provide an operator override to end an activity or extend the window.

In some aspects, security parameters for access control 848 may include a selectable cipher family and a session-level replay protection mechanism; all configuration states and changes may be serialized into audit logs 872 with record identifiers that support later traceability. In various aspects, traffic partitioning 852 may be implemented at multiple layers, such as by mapping operator flows and spectator flows to different application namespaces on low-latency message channel 840, by marking frames with distinct tags, or by binding them to separate virtual networks if the local wireless connectivity 810 supports multiple SSIDs. In certain aspects, role partitioning logic 854 may be invoked before any mutation is applied to the scoreboard scene graph, and violations may be rejected with a status code that is returned to the client and recorded for analysis.

In various aspects, the controller may support configuration profiles for different environments. In certain aspects, a “quiet-venue” profile may reduce transmit power and beacon rates and may increase the command-to-render latency bound 842 to conserve power during long events, while a “tournament” profile may increase beacon cadence, prefer lower-congestion channels, and narrow the latency bound. In some aspects, profiles may be switched manually from control interface UI 876 or automatically based on interference conditions detector 844 metrics and client density estimates.

In certain aspects, example data flows may be described to illustrate processing performed by programmatic interface 830 and normalization transformer 882. For instance, a service payload may include a JSON representation {“home”: “Falcons”, “away”: “Tigers”, “inning”: 3, “h”: 2, “a”: 4, “clock”: “06:00”}, which may be mapped to canonical fields such as team_home.name, team_away.name, period.value, score_home.value, score_away.value, and timer.seconds=360 under normalization transformer 882. In various aspects, an operator edit that changes “inning” from 3 to 4 may occur concurrently with a remote update that changes “score_away.value” from 4 to 5; conflict resolution may apply field-level independence so that both updates may be accepted, with ordering determined by source timestamps to resolve simultaneous edits to the same field.

In some aspects, practical deployments may include festivals, school fields, and emergency pop-up sites where external networks may be unreliable. In various aspects, local wireless connectivity 810 with traffic partitioning 852 may allow volunteers to manage the scoreboard while allowing participants or visitors to contribute to interactive prompts. In certain aspects, a screen-reader friendly version of control interface UI 876 may be served to improve accessibility, and language localization may be applied to onboarding and activity prompts based on a client's locale settings.

In various aspects, industrial applicability may include temporary venues that require autonomous, low-infrastructure signage with real-time data ingestion and local interactivity. In certain aspects, the controller may be integrated into rental fleets, and remote sync via secure transport 834 may be used by a central operations team to monitor device health logs and usage metrics recorded in audit logs 872 while preserving the offline-first rendering posture.

In some aspects, materials and mechanical choices for the radio subsystem may be described. In various aspects, the local wireless connectivity interface 812 may be positioned under a polymer window in the enclosure to reduce attenuation relative to metallic surfaces, and the radome material may include a UV-stabilized polycarbonate with a relative permittivity in the range of 2.5-3.2, which may provide acceptable transmission at 2.4 GHz and 5 GHz bands. In certain aspects, connector strain relief and cable routing near antenna feeds may be arranged to minimize coupling and preserve antenna impedance matching.

In certain aspects, failure modes may be addressed. In various aspects, if programmatic interface adapters 880 report malformed payloads, normalization transformer 882 may reject the payload and mark the adapter as degraded, with a visual indicator presented in control interface UI 876. In some aspects, if the low-latency message channel 840 experiences repeated timeouts, the controller may fall back to a periodic polling mode with larger frame updates at a reduced cadence until the persistent transport is restored.

In various aspects, testability may be improved by providing a sandbox mode in which simulated game-state feeds are published by programmatic interface 830 to evaluate render behavior without contacting external services. In certain aspects, synthetic spectator inputs 888 may be generated to validate rate limits and duplicate suppression, and audit logs 872 may capture expected values for later regression comparisons. In some aspects, a diagnostics export may be generated that includes operating channel selection logic 846 decisions and interference conditions detector 844 snapshots, which may be used by support staff to advise optimal placement of the unit at a venue.

In various aspects, optional backhaul links may be considered for remote sync via secure transport 834, such as a cellular modem or a venue-provided uplink; however, the local wireless connectivity 810 path for operator and spectator interactions may remain primary to preserve responsiveness. In certain aspects, when a backhaul is detected and authenticated, remote sync may occur at a configurable cadence, constrained by privacy and bandwidth policies specified in access control parameters 850.

In various aspects, enclosure materials may include UV-stabilized PC/ABS blends or glass-fiber-reinforced nylon to balance impact resistance and dimensional stability in outdoor use, and a silicone gasket with a nominal Shore A of 35-50 may be seated in a tongue-and-groove profile to achieve an ingress-protection rating when the door is latched. In some aspects, the radome region over the local wireless connectivity interface 812 may be molded from polycarbonate having a relative permittivity in the range of 2.5-3.2 and a thickness selected between 1.0-2.0 mm to limit dielectric detuning of the antenna. In certain aspects, EMI containment may be assisted by a selective conductive coating on internal walls, with keep-out zones around antennas, and mechanical fasteners may be anchored by brass heat-set inserts installed thermally into bosses to allow repeated servicing. In various aspects, the backplane rail that supports the power and data interconnect may be extruded aluminum (e.g., 6061-T6) with an anodized finish; cable ingress may be accomplished via IP-rated cable glands with tapered compression ferrules; and adhesive-lined heat-shrink tubing may be used to terminate harness branches. In some aspects, wire harnesses may be produced with crimp terminals validated to crimp height specifications (e.g., ISO/IPC), with pull-test acceptance criteria documented for quality checks, and potting compounds of appropriate dielectric strength may be applied to strain-relieved junctions subject to flexing during transport. In many aspects, adhesives compatible with polyolefin wire jacketing may be used for label retention in high-temperature conditions, and overmolded ferrite beads may be fitted on the low-latency message channel 840 lines to suppress common-mode emissions where applicable.

In various aspects, production verification may include conducted and radiated RF tests at sample intervals to characterize link margin for local wireless connectivity 810 under nominal and reduced supply voltages, and spectrum emission scans may confirm adherence to applicable spectral masks. In some embodiments, near-field scans of the radome region may be performed on first-article builds to validate antenna patterns when mounted on a metal fence substrate, and correlation data may be retained in audit logs 872 for traceability. In certain aspects, environmental screening may include temperature cycling between −10° C. and +50° C. with operational checks of the low-latency message channel 840 at dwell points, and humidity exposure may be applied to confirm that gasket compression sets remain within tolerance after repeated open/close cycles. In many aspects, fastening torque specifications may be documented for hinge hardware and latch/catch assemblies to avoid warping that could degrade sealing or antenna clearances.

In certain aspects, machine-readable pairing code 860 may be generated as a matrix symbol with error-correction level selected between M and Q for readability at distance, a minimum quiet zone of at least four modules, and a module size chosen relative to the display tile pixel pitch so that the rendered code subtends a visual angle adequate for scanning at 1-10 m. In various aspects, display tile drivers may select a high-contrast palette and temporarily disable animation layers to improve code stability during pairing, and a time-based one-time token encoded as ephemeral token 862 may rotate on a cadence between 15-120 seconds to reduce replay attempts. In some aspects, the controller may optionally display a text fallback short-code beneath the symbol for accessibility, and the captive portal may present a human-readable confirmation string derived from the token to allow an operator to verify they have joined the intended unit in multi-unit environments. In many aspects, symbol generation and token issuance may execute in constant time relative to symbol size to bound CPU usage on resource-constrained controllers.

In various aspects, audiovisual hardware that may be invoked by the celebration sequence may include a Class-D audio amplifier mounted on an isolated bracket to limit coupling into the display tile backplane, with loudspeakers rated for outdoor exposure and mounted with compliant gaskets to avoid water ingress. In certain aspects, a light-effect layer within the render pipeline may be parameterized to avoid saturating the low-latency message channel 840 during high-frequency updates by coalescing adjacent pixel operations into scanline blocks. In some aspects, adhesive-backed light pipes may be used to route status indicators to the enclosure surface where needed, and a serviceable connectorization scheme may allow replacement of speaker modules without disturbing the display tile wiring. In many aspects, end-of-line (EOL) test scripts may drive a synthetic threshold event and verify that the amplifier enable pin toggles and that the expected audio envelope appears on a coupler microphone, with results appended to audit logs 872.

In various aspects, power-path design may include back-to-back MOSFET ideal-diode arrangements to minimize reverse conduction and a bank of capacitors sized to support ride-through of transient current draw during hot-swap events. In certain aspects, the ride-through capacitance C may be estimated by C≈I·Δt/ΔV, where I may represent the peak current of the display tiles during a frame update, Δt may represent the hot-swap interruption interval, and ΔV may represent the allowable supply droop; an example selection may allocate 2000-8000 μF depending on tile count and desired voltage margin. In some aspects, battery modules may include a connector with staggered pin lengths to sequence ground, pre-charge, and power, and a pre-charge resistor path may limit inrush prior to MOSFET handover. In many aspects, thermal considerations may include a heat spreader bonded to the controller PCB in regions of high regulator dissipation and conductive interfaces to the enclosure for passive heat rejection, with derating tables stored in firmware to reduce brightness or message rate when temperature sensors indicate elevated conditions.

In certain aspects, firmware may be partitioned into a real-time task on a low-power microcontroller responsible for power-state control, watchdog feeding, and wake-event filtering, and an application task on a higher-power processor responsible for local wireless connectivity 810, programmatic interface 830, and interactive activity engine 886. In various aspects, the boot sequence may gate power to the application processor after a self-test confirms battery voltage, temperature range, and sufficient ride-through capacitance as measured by a brief load step, and a brownout detector may request a graceful shutdown if limits are exceeded. In some aspects, software may be built using a reproducible build pipeline, with artifacts signed and stored in a registry; an optional dual-bank update mechanism may be employed so that an active bank continues service while a staged bank is verified before a switchover at a maintenance window.

In certain aspects, a cost-effective fixture for EOL verification may be fabricated from laser-cut ABS panels to hold a commodity smartphone at a fixed distance and angle from the display surface during machine-readable pairing code 860 tests, and a camera-based pass/fail algorithm may be used to validate symbol contrast and quiet zone sufficiency against a minimum contrast ratio. In various aspects, a companion fixture may inject simulated programmatic interface 830 payloads over a wired backdoor diagnostic port to remove dependency on external networks during factory test, and the controller may enter a diagnostic persona where low-latency message channel 840 frames are looped back for latency estimation. In some aspects, RF slot tests may be conducted in a soft RF tent with absorbers to reduce multipath, enabling relative comparison of units without a full anechoic chamber.

In various aspects, mounting accessories may include a bent-steel hook with a corrosion-resistant finish for fence suspension, a woven polyester strap with a cam buckle for adaptable mounting, and a quick-release plate compatible with tripod standards; hardware may be rated for static loads with a safety factor to accommodate dynamic handling. In certain aspects, textile components may be die-cut for consistency and sewn with bar-tack reinforcements at stress points, and metallic components may be subjected to salt-fog exposure in development to identify coatings that provide durable performance. In some aspects, accessories may be supplied as a kit and may be stowed within an internal bay when not in use, and labels may indicate recommended mounting orientations relative to the antenna keep-out zones identified during radiated performance measurements.

Below is a technical enablement package that ties the claimed features to concrete hardware, software, data models, and protocols, and explains how the processes operate in practice. The details are written to provide support for § 112 enablement and description, address practical architecture choices, and document improvements that are technological in nature and not practicably performable in the human mind.
Controller hardware and display interconnect
Processing platform: The portable scoreboard controller may include a heterogeneous compute module having a high-performance application processor (e.g., quad-core ARM SoC running Linux) and a low-power microcontroller (e.g., ARM Cortex-M0/M4) connected via UART or I2C. The microcontroller may handle power sequencing, wake events, and watchdog servicing; the application processor may host networking, rendering, and programmatic interfaces.
Memory and storage: System memory may include 1-4 GB LPDDR4 RAM for scene composition and network buffers. Non-volatile storage may include 8-64 GB eMMC for the OS, application code, and local databases.
Reconfigurable modular display: The display may include multiple “display tiles” (e.g., RGB LED matrix panels or addressable tile modules). A power and data interconnect may be implemented as: (a) a differential data bus (e.g., RS-485, SPI-over-level-shifters, or HUB75-style parallel strobes) routed on or along a backplane rail; and (b) a DC power bus (e.g., 5 V or 12 V) with per-tile fusing. Each tile may expose a unique identifier (e.g., 32-bit UID stored in on-board EEPROM) readable over an auxiliary sideband (I2C/1-Wire) or via a discovery frame on the data bus.
Sensing: An ambient-light sensor may be connected to an ADC channel or I2C to inform brightness modulation. Optional inertial sensors may signal orientation for layout rotation.
Determining a layout of the reconfigurable modular display
Tile enumeration: On boot or reconfiguration, the controller may broadcast a “discover” message on the tile sideband (e.g., I2C address 0×50 broadcast) or inject a discovery frame on the data bus; tiles may respond with UID, tile type (pixel matrix size, e.g., 64×32), and mounting hints (optional DIP or magnetic orientation). The controller may time-slice responses to avoid collisions.
Layout solving: The controller may compute a layout mapping from logical scene coordinates to tile-local coordinates. A greedy or bipartite matching algorithm may be used to pack tiles into rows and columns given reported dimensions. If two orientations are plausible, a scoring function may select the arrangement that minimizes inter-tile seams or rotations. The layout may be recomputed within a target interval (e.g., <2 s) when tile attach/detach events occur (triggered by hot-plug GPIO edge or discovery delta).
Data structures: A “tile map” table may include fields: uid, origin_x, origin_y, width, height, orientation, bus_port, and electrical_index. A “scene graph” may reference the tile map when rasterizing.
Establishing local wireless connectivity for concurrent client devices
Access point (AP) mode: The controller may initiate AP mode using the onboard radio, set SSID, channel, and security (e.g., WPA2-Personal or an open SSID behind a captive portal). Hostapd-like services may be used. DHCP and DNS intercept may enable captive onboarding.
Concurrency: The controller may allow concurrent operator and spectator connections with connection tracking. A fairness scheduler at the application layer may bound per-client bandwidth for spectator endpoints.
Pairing: A machine-readable pairing code (QR or similar) may encode a one-time, time-bounded token (e.g., 128-bit nonce plus HMAC). A captive portal page may exchange the token for a role-scoped session credential (e.g., signed JWT with role=operator or role=spectator).
Transport: A low-latency message channel may be a secured WebSocket-like connection (WSS) between each client and the controller, framed with small binary messages for commands and display deltas. Keepalives and back-pressure signaling may be implemented.
Obtaining game-state data via a programmatic interface
Adapter abstraction: The controller may host a plug-in adapter layer that normalizes external scoring services (e.g., REST/JSON, Webhook, MQTT). Each adapter may implement fetch(), parse(), normalize(), and health() methods.
Normalization: The normalization transformer may map service-specific fields to an internal schema, for example:
team.home.name (string), team.away.name (string)
score.home (int), score.away (int)
period.value (int), period.label (string)
timer.seconds (int), timer.running (bool)
Conflict resolution: A deterministic policy may resolve collisions between operator edits and service updates. Field-level reconciliation may compare (source, timestamp, sequence) and apply precedence rules (e.g., external service for scores; operator override for team names). Rejected updates may be logged with reasons.
Rendering scoreboard graphics according to the layout
Render pipeline: The application may maintain a scene graph containing label nodes, numeric fields, icons, and animation layers. At each frame tick (e.g., 30-120 Hz target, dependent on hardware), the compositor may calculate the changed regions and issue tile-specific draw commands.
Tile driver: For HUB75-like tiles, the controller may update row shift registers and PWM planes using DMA-assisted GPIO (or a matrix bonnet). For addressable tiles (e.g., SPI/RS-485), the driver may packetize per-tile rectangular updates. PWM frequency and bit-plane scheduling may be chosen to reduce visible artifacts and to maintain brightness goals.
Brightness control: A brightness governor may take ambient-light readings and compute a target luminance (e.g., nit setpoint), adjusting PWM duty or global current settings. Thermal derating may reduce brightness if temperature exceeds a threshold.
Presenting interactive activity and receiving spectator inputs, then updating based on aggregated inputs and game-state data
Activity engine: The controller may run a finite-state machine for prompts, voting windows, and results. It may render UI overlays and accept spectator inputs over the low-latency channel or HTTP POST to a local endpoint.
Anti-abuse: Per-device rate limiting (token bucket) and duplicate suppression (hash of {session_id, prompt_id, option}) may be applied. Optional IP-based heuristics may mitigate floods in dense environments.
Aggregation: An aggregation window (fixed or sliding) may compute option counts, percentages, or scores. Threshold evaluation may fire a callback (e.g., play celebration, flash animation) when a condition (≥τ) is met. Aggregates may be combined with game-state (e.g., selecting a celebration that includes the current score).
Update logic: The update loop may merge the current normalized game-state with the activity result to produce a single render state. A diff engine may compute minimal tile updates to maintain latency targets.
Local databases, logs, and offline-first strategy
Data stores: A local relational database (e.g., SQLite with WAL mode) may persist normalized game-state snapshots, layout maps, audit logs, and configuration. A key/value store may cache adapter health and last-seen timestamps.
Offline-first: When adapters are unavailable, operator edits may continue to drive the render state. A retry queue may store outbound sync jobs for later execution. A queue schema may include job_id, endpoint, payload_hash, attempts, and next_retry_at.
Why this improves computer functionality and is not practically performed in a human mind
Improvements to technology: The system may reduce command-to-render latency via a local AP, a persistent low-latency channel, and tile-diff rendering that minimizes bus bandwidth. It may improve robustness using offline-first caching, deterministic conflict resolution, and dynamic channel selection based on real-time interference scanning. It may conserve power by coordinating PWM brightness with ambient and thermal sensors and by delegating power-state control to a low-power microcontroller.
Not humanly practicable: Enumerating tiles, solving layouts, driving hardware buses at kHz-MHz signaling rates, executing cryptographic token issuance/verification, maintaining dozens of concurrent sockets, and composing frames keyed to PWM planes and DMA timings are operations that require machine-level timing, parallelism, and numeric precision far beyond human capability.
Rail extrusion and conduit
Material and geometry: The elongated rail may be an aluminum extrusion (e.g., 6061-T6) with an internal conduit sized to carry a multi-conductor power harness and a shielded data cable. Cross-section may define a dovetail or T-slot for tile mounting clamps. Surface finish may be clear anodized for corrosion resistance.
Tolerances: Linear tolerance may be ±0.25 mm over 1 m; flatness and straightness may be controlled to keep tile faces co-planar. Holes for enclosure fastening may be CNC-drilled after extrusion to maintain positional accuracy.
Power and data interconnect installation
Cabling: The power harness may use 14-18 AWG conductors with insulation rated for the chosen DC voltage and ambient temperature. The data link may be a twisted pair for differential signaling or a ribbon for HUB75 pinout, with shielding and drain wire where appropriate.
Connectors: Polarized waterproof multi-pin connectors (e.g., IP65-IP67) may be crimped and overmolded; staggered pin design may sequence ground, pre-charge, and supply. Pull-test and hipot checks may be performed on assemblies.
Enclosure integration and tile mounting
Enclosure: PC/ABS or aluminum chassis may include gasketed seams, cable glands, and internal bosses with threaded inserts. The rail may be affixed with screws and Loctite or with rivet nuts to spread load.
Tile attachment: Tiles may be mounted with machine screws and captive washers into rail slots or standoffs. Torque specs may prevent PCB bowing. Alignment tabs or shims may be used to maintain seam uniformity.
Controller and power-management installation
Controller: The compute board and microcontroller board may be mounted on standoffs with thermal pads to a heat spreader. A harness may interconnect the controller with the rail bus through the internal conduit.
Power management: A power-path module may include ideal-diode MOSFETs, ride-through capacitors sized per load, a battery interface, and optional photovoltaic input to a charger. EMI filters may be placed at bus entry.
Verification
Electrical: Continuity, ground-bond, and insulation tests may be run. The system may be powered and the controller may enumerate tiles, render a test pattern, display a pairing code, and exercise adapter loopback endpoints. Latency checks may validate end-to-end response within target bounds.
Driving scoreboard graphics via the interconnect
The controller may compile the scene graph into tile-region updates. For HUB75 tiles, a DMA engine may fill PWM bit-planes while a scan controller steps rows; for differential addressed tiles, per-tile packets may be framed with header (tile UID, region) and payload (pixel data).
Interaction engine and local connectivity

The interaction engine may expose REST or WebSocket endpoints to spectator clients. Sessions may be authenticated with signed tokens. Operator UI may be a web application served locally with role-based controls.

The local wireless connectivity interface may implement AP mode with channel selection informed by interference scans. The AP may host multiple VLANs or logical namespaces separating operator and spectator traffic.
Enumeration and dual-sided configuration (dependent claim 20)
Enumeration: A sideband bus may collect UID and geometry for each tile. Attach/remove events may be detected by bus presence, hot-plug GPIO, or connector detect pins. The layout solver may update the tile map and trigger a re-render of the scene mapped to the new geometry.
Dual-sided: Two arrays mounted back-to-back may be modeled as two displays, each with its own layout object. The controller may maintain independent content pipelines per side but may share game-state. Phase coordination may ensure each side's PWM scan does not alias with the other side's frame timing and that power draw is balanced.
Ingestion interface

The ingestion interface may manage adapters, schedule periodic pulls or listen to webhooks, queue payloads for normalization, and merge resulting records into the internal state. Health monitoring may provide exponential backoff and fallback to a secondary adapter if the primary degrades.
APIs and protocols: HTTP/HTTPS for adapters; WebSockets for control and spectator inputs; mDNS for local discovery (optional). TLS may protect remote sync. DHCP/DNS for captive portal redirection in AP mode. UART/I2C for MCU-AP communication; I2C/1-Wire/SPI for tile sideband.
Data models: SQLite with normalized tables: tiles(uid, w, h, origin_x, origin_y, orientation); state(score_home, score_away, period, timer_s, updated_at, source); sessions(id, role, issued_at, expires_at); audit(id, ts, actor, action, details).
Logging and metrics: Structured logs (JSON lines) for audit; time-series ring buffers for latency samples; rotating files to manage storage.
Problem: Latency and jitter in field environments without reliable infrastructure networks. Solution: Local AP, persistent low-latency channel, and tile-diff rendering reduce end-to-end latency by keeping transport and compute local. This is a concrete improvement to computer networking and graphics composition on embedded systems.
Problem: Frequent reconfiguration of modular displays complicates addressing and mapping. Solution: Autodiscovery with per-tile UID, a deterministic layout solver, and on-the-fly remapping enable plug-and-play resizing. This enhances embedded display systems by automating geometry computation and minimizing operator actions.
Problem: Conflicts between external scoring feeds and concurrent operator edits. Solution: A deterministic field-level reconciliation policy with timestamps and priorities ensures consistent outcomes, with logs for traceability. This improves state synchronization in distributed human-in-the-loop embedded systems.
Problem: Spectator participation can overload control channels. Solution: Partitioned traffic with role-based namespaces, per-device rate limiting, and duplicate suppression protects operator control paths and maintains responsiveness.
Problem: Power interruptions during battery swaps cause visual resets. Solution: Power-path design with ideal-diode MOSFETs and ride-through capacitors maintains continuity through brief supply gaps.

Tile enumeration, layout solving, DMA-backed PWM plane scheduling, cryptographic session token management, multi-socket low-latency streaming, ambient/thermal closed-loop brightness control, and packet-level adapter parsing/normalization require high-speed computation, precise timing, and parallel state management that cannot be carried out reliably or timely by a human without specialized machines.
G. Concrete example sequences (tying steps to devices and interfaces)
Boot sequence: MCU powers SoC; SoC starts AP, DHCP, captive portal; tile discovery runs; tile map saved (SQLite); render pipeline composes initial scene; QR pairing code displayed for onboarding.
Operator action: Operator device connects to AP, scans QR, receives signed session token, opens UI; edit “score_home=3”; browser sends WebSocket command; controller reconciles state, updates DB, computes tile diffs, schedules draw; LEDs update within target latency bound; audit entry persisted.
Adapter update: Service adapter pulls “score_away=4”; normalization maps into internal schema; reconciliation applies external update for “score_away”; render pipeline updates display; UI reflects state; audit entry persisted.
Spectator round: Spectator device connects to AP; submits vote; rate limiter and dedup accept a single vote; aggregation window computes interim result; threshold fire triggers animation; logs captured.

These disclosures provide concrete structures, data flows, and algorithms that implement the claimed features across software, hardware, and manufacturing, and they explain how the system improves embedded networking and rendering under field constraints while operating in ways that are not practicably performable in the human mind.

Referring to FIG. 9, which illustrates a power system and battery-management architecture for a portable scoreboard controller, a power-path circuitry 910 910 may route energy among external inputs, a removable rechargeable battery, and regulated loads for the display tiles and logic subsystems. The power-path circuitry 910 910 may include power-path components 958 958 such as field-effect transistors, ideal-diode controllers, or controlled rectifiers that may reduce forward drop and may coordinate source selection between a battery and an auxiliary input. A bank of hold-up capacitors 920 920 may be arranged as a hold-up capacitors (assembly) 922 922 that may stabilize the output rail during source transitions and may support a ride-through interval 930 930 when a battery pack is hot-swapped or an external source is momentarily interrupted. In some aspects, the ride-through interval 930 930 may be characterized during production test and may be recorded for service reference.

A removable rechargeable battery interface 960 960 may provide a keyed electrical and mechanical connection for a battery pack that may include one or more electrochemical cells. The removable rechargeable battery interface 960 960 may be realized as a sled, latch, or multi-pin connector that may accommodate charge, discharge, and telemetry lines. In certain aspects, the removable rechargeable battery interface 960 960 may include pre-charge or inrush-control elements so that insertion may not produce excessive transient currents. Mechanical structures may be formed of polymer, aluminum, or composite materials with geometric features that may deter mis-insertion and may provide strain relief for pack leads.

A battery-management PCB 950 950 may host a protection and balancing controller 952 952 and a fuel-gauge device (BMS) 954 954. The protection and balancing controller 952 952 may monitor individual cell voltages and pack current and may open protective switches if measured parameters exceed configured limits. The fuel-gauge device (BMS) 954 954 may provide state-of-charge, state-of-health, and cycle-count estimates using coulomb counting and voltage models. The battery-management PCB 950 950 may be implemented on FR-4 or other PCB materials and may integrate sense resistors, thermistor inputs, and programming jumpers. In-circuit testing (ICT) 956 956 may be used to validate solder joints, basic analog measurements, and programming of device configuration prior to system integration.

Fuel-gauge telemetry 970 970 may be provided from the fuel-gauge device (BMS) 954 954 to a low-power microcontroller 980 980 and/or an application processor 982 982, and the data may be consumed by a runtime prediction 972 972 algorithm that may estimate minutes of remaining operation at a current or predicted load. The remaining-runtime UI 988 988 may present the estimate to an operator within a control interface so that event timing or power swaps may be planned. In some aspects, telemetry may include voltage, current, temperature, and impedance values that may be time-stamped and logged, and the runtime prediction 972 972 may be adaptive by incorporating display brightness, wireless activity, or interactive-activity engine load factors.

Temperature sensing limits 974 974 may define charge and operate windows for safe use of the cells, and a charge/operate limit control 978 978 may inhibit charging below or above configured temperatures and may reduce load under elevated temperature. The temperature sensing limits 974 974 may be implemented with one or more temperature sensors bonded to a cell surface or located on the battery-management PCB 950 950. In some aspects, the charge/operate limit control 978 978 may direct the power-path circuitry 910 910 to reduce display brightness or may signal the application processor 982 982 to suspend higher-power features such as certain animations, depending on policy.

An energy-extraction charger 942 942 may regulate energy obtained from a photovoltaic module 940 940 or other sources by controlling input point tracking and charge phases. A charger for photovoltaic module 962 962 may be a subcircuit of the energy-extraction charger 942 942 and may include input filtering, surge protection, and control elements that may accommodate panel voltage variations due to irradiance changes. The photovoltaic module 940 940 may be a hinged, foldable, or detachable panel that may connect through the removable rechargeable battery interface 960 960 area or a separate inlet. In certain aspects, the energy-extraction control 976 976 may implement an algorithm that may select an operating point for the photovoltaic module 940 940 and may coordinate with the charge/operate limit control 978 978 so that charging may be permitted only within safe temperature limits and appropriate pack voltage regions.

The low-power microcontroller 980 980 may manage standby states and power gating for the application processor 982 982, and may remain active at very low current to monitor wake events such as a user input, a schedule, or a battery threshold. When appropriate, the low-power microcontroller 980 980 may enable supply rails or control signals that power the application processor 982 982. The application processor 982 982 may execute rendering, networking, onboarding, and interactive-activity functionality and may consume the runtime prediction 972 972 and fuel-gauge telemetry 970 970 to select visual profiles or to present the remaining-runtime UI 988 988. In some implementations, the application processor 982 982 may orchestrate graceful shutdown when the fuel-gauge telemetry 970 970 indicates a low reserve, allowing the power-path circuitry 910 910 to transition to a protected state.

The hold-up capacitors (assembly) 922 922 may be dimensioned such that a target ride-through interval 930 930 may be achieved under nominal load, and the value may be selected considering the display refresh current and communication activity. The power-path components 958 958 may be arranged to limit reverse current and may include sense amplifiers to report source status to the low-power microcontroller 980 980. Board-level construction may include wide copper pours for thermal and current carrying capability, and connectors at the removable rechargeable battery interface 960 960 may be polarized and may include locking features to maintain contact under vibration typical of outdoor use.

An energy-extraction control 976 976 policy may arbitrate among available energy sources, for example selecting between the photovoltaic module 940 940 and a wall adapter, and may set charging current according to pack temperature and fuel-gauge telemetry 970 970. The charge/operate limit control 978 978 may reduce output load when measurements show that the cells are approaching low temperature limits or when internal temperature indicates elevated conditions. In some aspects, these policies may be updated through a service interface and checked during end-of-line procedures that include In-circuit testing (ICT) 956 956 and functional power tests.

Manufacturing and test operations may validate the battery-management PCB 950 950 using In-circuit testing (ICT) 956 956 and may program configuration parameters for the protection and balancing controller 952 952 and the fuel-gauge device (BMS) 954 954. System-level testing may exercise the power-path circuitry 910 910 by applying and removing sources while logging regulated rail continuity to confirm that the ride-through interval 930 930 is met within targets. A functional diagnostic may present the remaining-runtime UI 988 988 and verify that runtime prediction 972 972 responds to load changes such as display brightness adjustments. Placeholder paragraph for future FIG. 13 description paragraphs. A future power schematic figure may illustrate interconnections among the power-path components 958 958, hold-up capacitors (assembly) 922 922, energy-extraction charger 942 942, charger for photovoltaic module 962 962, and battery-management PCB 950 950, with example values and connector pinouts.

The power subsystem may integrate with the controller software so that remote updates and local diagnostics may read the fuel-gauge telemetry 970 970, temperature sensing limits 974 974, and policy states from the low-power microcontroller 980 980. Events such as hot-swap detection at the removable rechargeable battery interface 960 960, source-present transitions at the energy-extraction charger 942 942, or load-shed actions commanded by the charge/operate limit control 978 978 may be logged for later review. In some aspects, an operator may observe the remaining-runtime UI 988 988 within a control interface and may choose to connect the photovoltaic module 940 940 or reduce display brightness to extend runtime, and these actions may be reflected in the runtime prediction 972 972 output.

Mechanical and materials choices for the battery-management PCB 950 950 and the power-path circuitry 910 910 may consider outdoor deployment. Conformal coatings, gasketed compartments, and potting regions may be used near the power-path components 958 958 and the hold-up capacitors (assembly) 922 922. The photovoltaic module 940 940 may be configured with weather-resistant wiring and connectors that mate to a recessed port or a protected cable gland so that ingress protection ratings may be maintained. The removable rechargeable battery interface 960 960 may incorporate a cover or latch with detents that may allow quick exchanges in a field environment while helping to prevent accidental release.

During operation, the low-power microcontroller 980 980 may remain active during sleep and may periodically sample the fuel-gauge telemetry 970 970 to determine whether to wake the application processor 982 982 for scheduled tasks or notifications. When the application processor 982 982 is active, the rendering engine and networking stack may be powered while the charge/operate limit control 978 978 continues to monitor temperature sensing limits 974 974. If a battery exchange occurs, the power-path circuitry 910 910 may maintain output continuity using the hold-up capacitors (assembly) 922 922, and the low-power microcontroller 980 980 may log the event and update the runtime prediction 972 972 after the replacement pack is detected through the removable rechargeable battery interface 960 960.

Where a photovoltaic module 940 940 is employed, the energy-extraction charger 942 942 and the charger for photovoltaic module 962 962 may share telemetry with the application processor 982 982 so that the remaining-runtime UI 988 988 may present both current runtime and a projected runtime under available irradiance. In some deployments, mounting hardware for the photovoltaic module 940 940 may be included with the system enclosure and may support angle adjustments. Electrical protection elements such as transient suppressors and reverse-polarity protection within the power-path components 958 958 may be included to address probable field wiring conditions.

In various embodiments, the structural organization of the power system depicted in FIG. 9 may be adapted to different enclosure layouts without changing functional relationships among the power-path circuitry 910 910, the battery-management PCB 950 950, the low-power microcontroller 980 980, and the application processor 982 982. The described relationships may allow hot-swap operation, runtime estimation, temperature-based policy enforcement, and optional photovoltaic energy extraction while maintaining responsiveness for the modular display and local wireless connectivity described elsewhere.

Referring to FIG. 10, a diagnostic routine 1010 may be executed as a manufacturing end of line sequence and as a field service check to verify that networking, display, programmatic interfaces, interactivity, and audio visual subsystems operate within configured bounds for responsiveness and quality, and the diagnostic routine 1010 may log results for post process traceability and fleet analytics. Provisioning verification 1012 may confirm that a locally hosted access point and control service are active by issuing discovery probes and validating responses over the device's loopback and radio interfaces; in some embodiments, the provisioning verification 1012 may further validate that the SSID matches a per unit profile, that DHCP and captive portal services respond within a time window, and that the control interface serves a health page exposing firmware versions and configuration hashes, with all checks recorded as pass/fail entries under the diagnostic routine 1010 using latency metric capture 1054. Pairing code display verification 1014 may command the rendering stack to present a machine readable pairing code on the display, may scan the code using a handheld test client, and may verify that an onboarding endpoint opens and accepts a short lived token; the pairing code display verification 1014 may assert minimum contrast and module coverage so that the code remains readable when displayed on the reconfigurable modular display within expected ambient conditions. Enumeration/layout verification 1016 may issue an autodiscovery request over the tile interconnect, validate tile identifiers and capability flags against a bill of materials, compute the tile map, and compare the computed layout to a stored manufacturing configuration so that assembly errors are detected; in further checks, the enumeration/layout verification 1016 may request a forced re layout by temporarily masking a tile and may confirm that scene reflow preserves legibility within a configured target interval. API loopback verification 1018 may exercise the programmatic interface by invoking a local or remote loopback endpoint that returns a canonical dataset, which may be normalized and then rendered into a temporary overlay; the API loopback verification 1018 may assert that normalization, merge policy, and render paths complete within time budgets, and that the overlay matches an expected checksum across frames. Interactivity latency measurement 1020 may start a test round on the interactive engine, send synthetic spectator inputs from a test client through the local wireless path, and timestamp each stage of the pipeline—reception at the controller, aggregation, trigger evaluation, and display update—so that the end to end latency distribution is recorded and compared against acceptance thresholds for interactivity.

Locally hosted wireless connectivity (manufacturing test) 1030 may present a deterministic access point profile for automated stations, with a known SSID, passphrase, and channel selection; a test client may associate, request the captive portal, and receive a signed session token with a role limited to diagnostics so that sensitive operations remain restricted during production. The pairing code render (manufacturing test) 1032 may invoke the same rendering path used in normal operation, ensuring that code generation, placement, and modulation parameters are validated against the physical display; the test station may record an image and compute a decode confidence score. Tile enumeration (manufacturing test) 1034 may store discovered tile identifiers and measured voltages/temperatures into device storage, linking physical modules to serial records; a subsequent readout from service tools may present this mapping to technicians for rapid diagnosis. Programmatic interface loopback (manufacturing test) 1036 may issue a signed request to a loopback handler that returns a synthetic, versioned score payload, which the controller may parse through the adapter layer and normalization transformer; the result may be rendered in a reserved test region so that the operator can visually verify digits, fonts, and alignment. Interactive latency measure (manufacturing test) 1038 may run multiple trials while varying load on the low latency message channel and on the renderer to characterize the impact of activity density on the interactivity path; results may be summarized as median and upper percentile values and stored with the unit's manufacturing log.

A microphone input 1040 may receive audio from a cabled microphone jack, a line level input, or a wireless microphone link, and the microphone input 1040 may generate a digital stream for processing in the audio path. Gain control 1042 may apply variable gain using automatic or operator specified settings and may include a limiter that clamps peaks to avoid clipping at the amplifier; for example, a compressor with attack and release parameters may be used to keep speech intelligible when the loudness varies. Ducking control 1044 may lower background music or sound effects when speech is detected so that announcements remain clear; ducking may be triggered by a voice activity detector operating on the microphone input 1040 and may attenuate the background mix by a configurable decibel value with a specified attack/release envelope to minimize pumping artifacts. Audio visual alignment 1046 may synchronize audio cues with visual events from the renderer such that celebration sounds, stingers, or chimes are launched at defined frame boundaries; timestamps produced by the rendering subsystem may be used to schedule audio playback to coincide with a frame start, providing consistent perceptual alignment across runs. An audio output path 1048 may include a digital to analog converter, equalization, a power amplifier, and one or more speakers integrated into the enclosure or connected externally; high pass filtering may be applied to prioritize speech bands in public address use cases, with optional profiles for music playback when desired.

A visual effects control 1050 may coordinate animation layers, overlays, and color changes that appear when triggers are received from game events, programmatic adapters, or the interactive engine. In some embodiments, the visual effects control 1050 may prepare effect assets in a sprite atlas and schedule frame updates at safe windows provided by the renderer's modulation settings to reduce recording artifacts under rolling shutter. Synchronized audio visual effects 1052 may combine commands issued to the audio output path 1048 and the visual effects control 1050, with a scheduler that ensures a launch offset Δt close to zero at the display's frame boundary; the audio visual alignment 1046 may adjust for known latencies in speaker amplification paths or Bluetooth links by launching audio slightly earlier relative to the frame so that the sound and visuals appear aligned to a spectator. Latency metric capture 1054 may instrument key subsystems—including the low latency message channel, rendering pipeline, audio scheduler, and interactive aggregation path—to capture per stage timings; markers may be recorded on both CPU and GPU timelines, and optical sensors may be used during manufacturing to confirm true frame to light latencies on the physical display for calibration of the scheduler.

The diagnostic routine 1010 may present a compact operator UI for field use where technicians step through provisioning verification 1012, pairing code display verification 1014, enumeration/layout verification 1016, API loopback verification 1018, and interactivity latency measurement 1020. In a field scenario, the locally hosted wireless connectivity (manufacturing test) 1030 may be replaced by a “venue check” profile that confirms that onboard radios are configured to the event's policy and that channel selection strategies remain within configured limits; a simple green/yellow/red indicator may inform event staff whether the network path is sufficient before play begins. For fleet administrators, results may be exported when connectivity exists through a secure channel, allowing remote review of failure modes and recovery steps.

For the audio chain, the microphone input 1040 may be mixed with music sourced from a local device or from a streaming input when permitted; gain control 1042 and ducking control 1044 may be tuned so that speech always overrides background audio. An operator may test the chain by pressing a “speak” button that plays a test phrase; the latency metric capture 1054 may measure the time from the button press to acoustic output via a small test microphone placed near the speaker, and the audio visual alignment 1046 may then step through offsets to produce a perceptually aligned result for spectator experience. Where the enclosure integrates speakers, the audio output path 1048 may include thermal protection that reduces gain at high temperatures, and the diagnostic routine 1010 may record this condition in logs to guide staging decisions in direct sun.

The visual effects control 1050 may support templates for different sports, with effects mapped to milestones such as home run animations for baseball or goal flashes for soccer; synchronized audio visual effects 1052 may be activated by the threshold evaluation engine described in earlier figures when interactive activities reach targets. Operators may set “quiet hours” so that audio cues are suppressed during certain times or in venues with noise restrictions, while visuals continue to display effects without sound. In dual sided installations, the visual effects control 1050 may render distinct overlays on opposing faces while a single audio event plays omni directionally, and the audio visual alignment 1046 may anchor both faces' animation starts to the same frame boundary.

In addition to per subsystem checks, the diagnostic routine 1010 may include a “quick pass” mode for pre game checks where pairing code display verification 1014 and enumeration/layout verification 1016 are run automatically, and interactivity latency measurement 1020 is run with a small synthetic input so that staff may confirm responsiveness. A “deep pass” mode may run the entire suite including programmatic interface loopback verification 1018 and extended audio visual checks; logs may be tagged with venue, time, and device identity for later audits. Acceptance thresholds may be configurable, and fleet owners may set stricter bounds for championship events where responsiveness and A/V synchronization are prioritized.

Manufacturing stations may chain the 1030-1038 test steps under the diagnostic routine 1010 with a barcode driven traveler that records results against the unit's serial. The pairing code render (manufacturing test) 1032 may be verified by a station camera whose OCR or QR decoder reports a score and decodes the embedded ephemeral token; results outside tolerance may prompt station rework. The tile enumeration (manufacturing test) 1034 may include a simple pixel fill and checkerboard sweep to look for dead rows or columns, and the enumeration/layout verification 1016 may assert that scene mapping respects the tile map. For audio tests, a fixture may measure frequency response and distortion of the audio output path 1048 while the device plays test sweeps, and the microphone input 1040 path may be checked by loopback to the audio output path 1048 with optional out of phase tests to detect wiring issues.

To provide comprehensive tracing, the latency metric capture 1054 may correlate network timestamps from the low latency message channel, internal CPU timestamps, and a photodiode or high speed camera measurement of display updates. Where elevated precision is needed, the system may measure full round trip latency by displaying a coded pattern when a test command is received and reading a sensor's report over the local channel, thereby incorporating both radio and rendering contributions. Results may be used to tune scheduler parameters and to adapt the renderer's update cadence under load to maintain the command to render latency within configured bounds.

In embodiments where the device is used as a portable public address system as well as a scoreboard, the microphone input 1040 and gain control 1042 may offer presets such as “handheld dynamic,” “lavalier,” or “line,” and ducking control 1044 may include modes tailored to speech clarity in noisy environments. The audio visual alignment 1046 may present a visual countdown on screen while arming a cue so that an announcer knows when to speak for coordinated reveal moments; synchronized audio visual effects 1052 may then launch with precise on screen timing.

In some implementations, the diagnostic routine 1010 may expose an API for remote automated test harnesses so that devices staged in a depot can be verified overnight; provisioning verification 1012 and programmatic interface loopback verification 1018 may use local emulators when backhaul is unavailable. In a rental workflow, a “return scan” may run pairing code display verification 1014, enumeration/layout verification 1016, and interactivity latency measurement 1020 after cleaning and charge, and any failures may automatically generate a service ticket with stored logs.

Where a dual processor architecture is employed for low power standby, the diagnostic routine 1010 may include a suspend/resume check that validates that locally hosted services remain discoverable after wake, that the tile enumeration state remains consistent, and that audio visual synchronization parameters remain valid. Latency metric capture 1054 may record pre and post suspend latency to detect anomalies indicative of driver re initialization issues. For long outdoor deployments with optional solar charging, the diagnostic routine 1010 may exercise the power subsystem by stepping through load profiles while recording rail stability, ensuring that audio output path 1048 and rendering remain stable during dynamic power conditions.

The combined test and A/V controls of FIG. 10—specifically the diagnostic routine 1010 with provisioning verification 1012, pairing code display verification 1014, enumeration/layout verification 1016, API loopback verification 1018, interactivity latency measurement 1020, and manufacturing test steps 1030 through 1038, together with the microphone input 1040, gain control 1042, ducking control 1044, audio visual alignment 1046, audio output path 1048, visual effects control 1050, synchronized audio visual effects 1052, and latency metric capture 1054—may provide a structured approach to validating and operating the portable system so that responsiveness, reliability, and spectator experience remain within configured targets across manufacturing, staging, and live event contexts.

Referring to FIG. 11, which illustrates a controller software stack and data-flow architecture for a portable scoreboard system, a controller core 1110 may host cooperating services that collectively provide local wireless connectivity, programmatic ingestion, interactive participation, rendering, and diagnostics. The controller core 1110 may execute on an application processor and may coordinate with a low-power counterpart as described elsewhere, and may expose web or application endpoints to client devices. In some aspects, the controller core 1110 may be packaged as one or more processes that share state through a local datastore and message bus.

A local wireless connectivity service 1120 may provide association and session management for client devices that connect without external infrastructure, and may be integrated with an access-point manager 1122 for radio configuration and channel control. The local wireless connectivity service 1120 may operate with a low-latency channel engine 1124 that maintains a bidirectional message stream between the controller core and clients for control and rapid display updates. In some aspects, a security and access control module 1126 may enforce authentication and session scoping and may cooperate with a session credential issuer 1188 to issue operator and spectator tokens. A pairing code generator 1186 may render a machine-readable pairing code on the display, and the local wireless connectivity service 1120 may accept onboarding requests that include an ephemeral token derived from the pairing code.

An adapter layer 1130 may interface with external scoring sources and may instantiate one or more adapter instances 1132 to communicate with distinct services. Payloads arriving from the adapter layer 1130 may be transformed by a normalization transformer 1134 into an internal schema stored within a schema store 1136. In some aspects, an offline-first cache may persist normalized game-state objects and may enqueue outbound updates for later transmission to remote endpoints. A remote synchronization service 1199 may receive subsets of state over a secure channel as dictated by configuration, while local rendering remains available when external links are intermittent.

A conflict-resolution engine 1140 may reconcile normalized game-state updates with local operator edits, using a timestamp comparator 1142 that may compare source times and an editable field priority table 1144 that may represent role or source precedence by field. When a field is updated, an audit logger 1146 may record the action, including the actor, source, and resolution outcome. In some aspects, the conflict-resolution engine 1140 may expose deterministic policies such as last-writer-wins at field granularity or service-preferred on specific fields, and configuration may be changed through an administrative interface.

A render pipeline 1150 may convert current scene state into display outputs. A scene graph builder 1152 may assemble visual nodes such as team labels, scores, period indicators, count clusters, or base-occupancy glyphs, and a layout mapper 1154 may place those nodes according to a computed layout. A tile bus driver 1156 may translate the final scene buffers into transfer bursts on a data bus to the display tiles, and an ambient-light controller 1158 may adjust brightness using sensor input to reduce visual artifacts in recorded video under varying illumination. In some embodiments, the render pipeline 1150 may provide a dual-side coordinator that manages phase alignment when driving dual-sided displays so that opposing faces may render independent scenes with coordinated refresh. A layout and autodiscovery service 1160 may maintain a tile map produced by a discovery engine 1162 and may cache layout metadata in a layout cache 1164, recomputing placement after tile attach or removal events within a target interval.

An interactive activity engine 1170 may publish prompts and collect audience responses from connected spectator devices. To manage load and fairness, a rate limiter 1172 may constrain per-device submissions according to configurable windows, and a duplicate-input suppression module 1174 may filter repeated votes from the same session or device fingerprint. Submitted responses may be consolidated by an aggregation engine 1176 that may compute counts, means, or rankings over a window, and a threshold evaluation engine 1178 may test the aggregate value against one or more thresholds and signal the render pipeline 1150 when a trigger condition is met. In some aspects, the interactive activity engine 1170 may supply result values to the scene graph builder 1152 to produce a visualization such as a bar graph, badge, or banner with synchronized audio cues as described elsewhere.

A data stores and configuration block 1180 may retain operational parameters and may include tables for roles, privileges, and field priorities. A runtime metrics monitor 1182 may collect latency, throughput, and error counters such as command-to-render intervals and adapter response times. A diagnostic suite 1184 may expose tests that verify provisioning of local networking, display of a pairing code, enumeration and layout formation, loopback of the programmatic interface path, and interactive activity latency; results may be recorded for end-of-line manufacturing or in-field checks and may be exported through logging endpoints. In some cases, the diagnostic suite 1184 may drive a scripted test sequence that exercises key operations in a known order while monitoring render timing.

A session credential issuer 1188 may mint signed tokens or short-lived credentials for operator control sessions and spectator sessions, and may embed role information so that permission checks can be performed at endpoints and in the security and access control module 1126. The pairing code generator 1186 may periodically rotate the ephemeral token embedded in the pairing code and may coordinate with the local wireless connectivity service 1120 so that expired tokens are not accepted. In some configurations, an operator enrolling through the pairing screen may be prompted to select a role; the session credential issuer 1188 may enforce policies that restrict role assignments to authenticated or pre-approved devices.

A client devices group 1196 may include operator smartphones, tablets, or laptops, while a spectator devices group 1197 may include general audience smartphones. The local wireless connectivity service 1120 may provide separate namespaces or logical channels so that operator traffic and spectator traffic remain segregated. The low-latency channel engine 1124 may maintain per-client or per-role channels that carry messages such as score edits, scene selections, or spectator responses, and may coalesce updates to minimize bandwidth while preserving command-to-render responsiveness.

External scoring services 1198 may publish game-state records through APIs that the adapter layer 1130 may consume. The adapter instances 1132 may perform pagination, authentication, and retry logic according to service requirements, and the normalization transformer 1134 may map fields such as teams, scores, inning or period indicators, and event codes to the internal schema maintained in the schema store 1136. When a normalized object arrives, the conflict-resolution engine 1140 may integrate the fields with local state, and the render pipeline 1150 may be notified so that the scene graph builder 1152 may update visible elements. A secure export via the remote synchronization service 1199 may publish selected state to a remote endpoint when configured, and the offline-first cache may buffer exports for later transmission.

A battery and power telemetry interface 1190 may provide remaining-runtime and temperature information derived from the power subsystem, and a runtime predictor 1192 may compute estimates for remaining operation time. An operator-facing configuration UI server 1194 may present this value to users in the control interface and may permit display brightness adjustments, which the render pipeline 1150 may apply. In some aspects, the runtime predictor 1192 may incorporate render load, ambient brightness targets, and network activity in its estimate, and the runtime metrics monitor 1182 may log the prediction and realization to improve future estimates.

Assembly and deployment of the controller software stack shown in FIG. 11 may include launching the local wireless connectivity service 1120 and access-point manager 1122, configuring the low-latency channel engine 1124, starting the adapter layer 1130 with one or more adapter instances 1132, and initializing the layout and autodiscovery service 1160 to produce an initial tile map. After the pairing code generator 1186 renders a code, operator devices in the client devices group 1196 may onboard and receive role-based credentials through the session credential issuer 1188. The operator may select a sport layout through the configuration UI server 1194, causing the scene graph builder 1152 and layout mapper 1154 to create a scene that the tile bus driver 1156 may transmit to the display tiles. If an external scoring service 1198 is enabled, the adapter layer 1130 may begin polling or subscribing and may feed normalized updates to the conflict-resolution engine 1140 for integration. If an interactive activity is launched, the interactive activity engine 1170 may publish a prompt and accept responses from the spectator devices group 1197, and the aggregation engine 1176 may compute and deliver results back to the render pipeline 1150.

During operation, the runtime metrics monitor 1182 may periodically measure command-to-render latency for operator edits arriving over the low-latency channel engine 1124. If an excursion is detected, the diagnostic suite 1184 may be invoked to test networking or rendering, and results may be written to the audit logger 1146 with correlation identifiers. If the discovery engine 1162 detects a change in connected tiles, the layout and autodiscovery service 1160 may recompute the layout cache 1164 and notify the render pipeline 1150, which may reflow the scene graph builder 1152 and the layout mapper 1154 without interrupting local networking.

The controller core 1110 may host optional audio handling that maps event triggers from the threshold evaluation engine 1178 or scoring events from normalized records to synchronized audio cues. In this case, the render pipeline 1150 may schedule graphical effects while an audio subsystem plays corresponding audio files, and the audit logger 1146 may record trigger and playback times. The ambient-light controller 1158 may continue to adjust brightness so that the visual effect remains legible without requiring manual intervention.

In various arrangements, the modules in FIG. 11 may be deployed as processes within a single controller node, or as containers communicating through loopback interfaces; the interfaces between blocks may be gRPC, REST, or a message broker. The layout and autodiscovery service 1160 may accept plug-ins for different tile interconnects and may adapt to a monolithic display that exposes a logical tile interface. The adapter layer 1130 may add or remove adapter instances 1132 at runtime as services are enabled or disabled, and the security and access control module 1126 may enforce updated policies immediately by consulting the data stores and configuration block 1180.

A commissioning routine may exercise the diagnostic suite 1184 in sequence: provisioning of the local wireless connectivity service 1120, display of a pairing code via the pairing code generator 1186, onboarding and session issuance via the session credential issuer 1188, enumeration through the discovery engine 1162, render latency timing through the low-latency channel engine 1124, and external service loopback by directing the adapter layer 1130 at a test endpoint. Completion of these checks may be recorded by the audit logger 1146 and may be visible in a commissioning report through the configuration UI server 1194.

Through the arrangement depicted, FIG. 11 may provide structural and functional support for local wireless connectivity and onboarding, adapter-based programmatic ingestion and normalization, deterministic conflict resolution, scene-graph rendering to a reconfigurable modular display, ambient-light-responsive modulation, audience interactivity with rate limiting, duplicate suppression, aggregation and thresholds, secure remote synchronization, runtime prediction and telemetry, and a comprehensive diagnostics framework, with each module identified to guide implementation and integration with the physical assemblies described in other figures.

FIG. 1 is a flowchart of an example method for . . . [A non-transitory machine-readable storage medium comprising instructions that, when executed by one or more processors of a portable scoreboard controller operatively coupled to a reconfigurable modular display comprising a plurality of display tiles interconnected by a power and data interconnect, cause the controller to:]

At step 110, the system determines the layout of the reconfigurable modular display. At step 120, it establishes local wireless connectivity to accept concurrent connections from client devices without relying on external networking infrastructure. At step 130, it obtains game-state data from at least one external source via a programmatic interface. At step 140, the system renders scoreboard graphics in accordance with the determined layout. At step 150, it presents an interactive activity on the reconfigurable modular display and receives spectator inputs through the local wireless connectivity. At step 160, the system updates the display based on the game-state data and the aggregation of spectator inputs.
Clause 1. A non-transitory machine-readable storage medium comprising instructions that, when executed by one or more processors of a portable scoreboard controller operatively coupled to a reconfigurable modular display comprising a plurality of display tiles interconnected by a power and data interconnect, cause the controller to: determine a layout of the reconfigurable modular display; establish local wireless connectivity to accept concurrent connections from client devices without reliance on external networking infrastructure; obtain game-state data from at least one external source via a programmatic interface; render scoreboard graphics according to the layout; present an interactive activity on the reconfigurable modular display and receive spectator inputs via the local wireless connectivity; and update the reconfigurable modular display based at least on the game-state data and an aggregation of the spectator inputs.
Clause 2. The non-transitory machine-readable storage medium of clause 1, wherein establishing local wireless connectivity comprises: rendering on the reconfigurable modular display a machine-readable pairing code encoding an ephemeral token; and executing a local onboarding flow that issues role-based session credentials to operator devices, partitions operator control channels from spectator traffic, and limits spectator access to the interactive activity.
Clause 3. The non-transitory machine-readable storage medium of clause 1, wherein determining the layout comprises: broadcasting an autodiscovery message over data lines of the power and data interconnect; receiving unique identifiers stored in non-volatile memory on respective display tiles; recomputing the layout within a target interval responsive to attachment or removal of a display tile; and supporting a monolithic panel that exposes a logical tile interface compatible with the layout computation.
Clause 4. The non-transitory machine-readable storage medium of clause 1, wherein rendering scoreboard graphics comprises: composing a scene graph including team identifiers, score values, and a period indicator; mapping the scene graph to the layout; maintaining a command-to-render latency within a target bound using a bidirectional low-latency message channel; and adjusting display brightness in response to an ambient-light sensor using a modulation scheme having parameters that reduce visible artifacts in recorded video.
Clause 5. The non-transitory machine-readable storage medium of clause 1, wherein obtaining game-state data comprises: invoking an adapter abstraction for a plurality of external scoring services; normalizing responses to an internal schema; resolving conflicts between operator edits and normalized game-state data using a deterministic policy based on source timestamps and field-level priorities; and persisting cached data with retry and backoff to maintain offline-first operation.
Clause 6. The non-transitory machine-readable storage medium of clause 1, wherein presenting the interactive activity comprises: enforcing per-device rate limits and duplicate-input suppression; aggregating spectator inputs within defined time windows; and triggering synchronized audio-visual effects upon reaching a threshold condition derived from aggregated spectator inputs or game-state data.
Clause 7. The non-transitory machine-readable storage medium of clause 1, further comprising: configuring the local wireless connectivity with security parameters for access control; selecting an operating channel based on interference conditions among co-located scoreboards; and synchronizing a subset of the game-state data with a remote service using a secure transport while maintaining local rendering when the remote service is unavailable.
Clause 8. The non-transitory machine-readable storage medium of clause 1, wherein rendering on a dual-sided configuration comprises: driving first and second arrays of the display tiles with independent content selections; and coordinating refresh phases across the arrays according to a phase relationship that reduces perceptible artifacts.
Clause 9. The non-transitory machine-readable storage medium of clause 1, wherein managing power states comprises: operating a low-power microcontroller that monitors wake events and gates power to a higher-power application processor; maintaining display output during hot-swapping of a removable rechargeable battery by controlling power-path circuitry and hold-up capacitors providing ride-through beyond a target interval; and harvesting energy from a photovoltaic module using a charger configured to extract energy from incident light.
Clause 10. The non-transitory machine-readable storage medium of clause 1, further comprising: computing runtime predictions from fuel-gauge telemetry; enforcing charge and operation limits based on temperature sensing; and presenting remaining-runtime estimates within a control interface of the controller.
Clause 11. The non-transitory machine-readable storage medium of clause 1, further comprising: providing a scene configuration interface that accepts declarative layout data; and compiling the declarative layout data into the scene graph used by a render pipeline for the reconfigurable modular display.
Clause 12. The non-transitory machine-readable storage medium of clause 1, wherein handling audio comprises: accepting microphone input for public-address functionality; applying gain control and ducking to lower background audio during announcements; and aligning audio cues with visual effects at defined trigger points.
Clause 13. The non-transitory machine-readable storage medium of clause 1, wherein the local onboarding flow issues signed session tokens to operator devices and records audit logs of role-scoped operations.
Clause 14. The non-transitory machine-readable storage medium of clause 1, further comprising: executing a diagnostic routine that verifies provisioning of the local wireless connectivity; display of the machine-readable pairing code; enumeration of display tiles and layout formation; loopback of the programmatic interface; and interactive activity latency against acceptance thresholds for end-of-line testing.
Clause 15. A method of manufacturing a portable interactive scoreboard assembly comprising: extruding or procuring an elongated rail that defines an internal conduit; installing within the internal conduit a power and data interconnect terminated by polarized waterproof multi-pin connectors; affixing the elongated rail to or within an enclosure; mechanically attaching a plurality of display tiles to the elongated rail and mating the display tiles to the polarized waterproof multi-pin connectors to form a reconfigurable modular display; and installing a controller and a power-management circuit within the enclosure and electrically coupling the controller to the power and data interconnect.
Clause 16. The method of clause 15, further comprising: forming a soft-shell variant by cutting fabric panels; RF welding or seam-sealing the fabric panels to form an enclosure with transparent windows and integrated fence straps; integrating a stiffener that retains the elongated rail; routing the power and data interconnect through strain-relieved pass-throughs with potting compound; and verifying an ingress-protection rating by water-spray testing window seams and pass-throughs.
Clause 17. The method of clause 15, further comprising: forming a rigid variant by injection-molding polymer panels with molded-in bosses for captive fasteners and tripod-thread inserts; installing silicone gaskets at panel joints and a gasketed service door; sealing the enclosure with gasketed closures that provide an ingress-protection rating; mounting magnetic attachment plates; sealing cable glands; coupling a heat spreader to the elongated rail; and verifying enclosure integrity by pressure-decay testing or leak testing.
Clause 18. The method of clause 15, further comprising: assembling a battery-management printed circuit board by surface-mount soldering a protection and balancing controller and a fuel-gauge device; performing in-circuit testing; installing power-path components and hold-up capacitors that support hot-swapping of a removable rechargeable battery; providing a removable rechargeable battery interface; integrating a charger for a photovoltaic module; and performing an end-of-line test comprising powering the assembly, establishing locally hosted wireless connectivity, rendering a machine-readable pairing code on the reconfigurable modular display, enumerating the display tiles to form a layout, verifying a programmatic interface loopback, and measuring interactive activity responsiveness within a target latency.
Clause 19. A portable interactive scoreboard system comprising: a reconfigurable modular display including a plurality of display tiles mechanically attachable to a backplane providing a power and data interconnect; a controller operatively coupled to the reconfigurable modular display and configured to drive scoreboard graphics on the display tiles via the power and data interconnect; and an interaction engine of the controller configured to present an interactive activity on the reconfigurable modular display and to receive spectator inputs via a local wireless connectivity provided by the controller; wherein the controller updates the reconfigurable modular display based at least on game-state data received via a programmatic interface and an aggregation of the spectator inputs.
Clause 20. The system of clause 19, wherein: the controller is configured to enumerate the display tiles over the power and data interconnect to determine a layout, recompute the layout responsive to attachment or removal of a display tile, and drive a dual-sided configuration with independent content selections for respective sides; the system further comprises a local wireless connectivity interface of the controller configured to accept concurrent connections from multiple client devices without reliance on external networking infrastructure; and the controller comprises an ingestion interface configured to obtain game-state data from at least one external source via the programmatic interface.

### Additional Embodiments

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily

### Conclusion

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer. It is to be understood that the present technology contemplates that, to the extent possible, one or more features of any implementation can be combined with one or more features of any other implementation.

While the above description details certain embodiments of the invention and describes the best mode contemplated, no matter how detailed the above appears in text, the invention can be practiced in many ways. Therefore, implementation details may vary considerably while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated.

Any specific manifestations of these and other similar example processes are not intended to be limiting to the disclosure. Any suitable manifestation of these and other similar example processes can be selected within the scope of the illustrative embodiments.

Thus, a computer-implemented method, system or apparatus, and computer program product are provided in the illustrative embodiments for [[TITLE]] and other related features, functions, or operations. Where an embodiment or a portion thereof is described with respect to a type of device, the computer-implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present disclosure may be a system, a method, and/or a computer program product at any possible technical detail level of integration. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on a dedicated system or user's computer, partly on the user's computer or dedicated system as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A non-transitory machine-readable storage medium comprising instructions that, when executed by one or more processors of a portable scoreboard controller operatively coupled to a reconfigurable modular display comprising a plurality of display tiles interconnected by a power and data interconnect, cause the controller to:
determine a layout of the reconfigurable modular display;
establish local wireless connectivity to accept concurrent connections from client devices without reliance on external networking infrastructure;
obtain game-state data from at least one external source via a programmatic interface;
render scoreboard graphics according to the layout;
present an interactive activity on the reconfigurable modular display and receive spectator inputs via the local wireless connectivity; and
update the reconfigurable modular display based at least on the game-state data and an aggregation of the spectator inputs.

2. The non-transitory machine-readable storage medium of claim 1, wherein establishing local wireless connectivity comprises:
rendering on the reconfigurable modular display a machine-readable pairing code encoding an ephemeral token; and executing a local onboarding flow that issues role-based session credentials to operator devices, partitions operator control channels from spectator traffic, and limits spectator access to the interactive activity.

3. The non-transitory machine-readable storage medium of claim 1, wherein determining the layout comprises:
broadcasting an autodiscovery message over data lines of the power and data interconnect;
receiving unique identifiers stored in non-volatile memory on respective display tiles;
recomputing the layout within a target interval responsive to attachment or removal of a display tile; and
supporting a monolithic panel that exposes a logical tile interface compatible with the layout computation.

4. The non-transitory machine-readable storage medium of claim 1, wherein rendering scoreboard graphics comprises:
composing a scene graph including team identifiers, score values, and a period indicator; mapping the scene graph to the layout;
maintaining a command-to-render latency within a target bound using a bidirectional low-latency message channel; and adjusting display brightness in response to an ambient-light sensor using a modulation scheme having parameters that reduce visible artifacts in recorded video.

5. The non-transitory machine-readable storage medium of claim 1, wherein obtaining game-state data comprises: invoking an adapter abstraction for a plurality of external scoring services;
normalizing responses to an internal schema; resolving conflicts between operator edits and normalized game-state data using a deterministic policy based on source timestamps and field-level priorities; and
persisting cached data with retry and backoff to maintain offline-first operation.

6. The non-transitory machine-readable storage medium of claim 1, wherein presenting the interactive activity comprises:
enforcing per-device rate limits and duplicate-input suppression; aggregating spectator inputs within defined time windows; and
triggering synchronized audio-visual effects upon reaching a threshold condition derived from aggregated spectator inputs or game-state data.

7. The non-transitory machine-readable storage medium of claim 1, further comprising:
configuring the local wireless connectivity with security parameters for access control;
selecting an operating channel based on interference conditions among co-located scoreboards; and
synchronizing a subset of the game-state data with a remote service using a secure transport while maintaining local rendering when the remote service is unavailable.

8. The non-transitory machine-readable storage medium of claim 1, wherein rendering on a dual-sided configuration comprises:
driving first and second arrays of the display tiles with independent content selections; and
coordinating refresh phases across the arrays according to a phase relationship that reduces perceptible artifacts.

9. The non-transitory machine-readable storage medium of claim 1, wherein managing power states comprises:
operating a low-power microcontroller that monitors wake events and gates power to a higher-power application processor;
maintaining display output during hot-swapping of a removable rechargeable battery by controlling power-path circuitry and hold-up capacitors providing ride-through beyond a target interval; and
harvesting energy from a photovoltaic module using a charger configured to extract energy from incident light.

10. The non-transitory machine-readable storage medium of claim 1, further comprising: computing runtime predictions from fuel-gauge telemetry;
enforcing charge and operation limits based on temperature sensing; and
presenting remaining-runtime estimates within a control interface of the controller.

11. The non-transitory machine-readable storage medium of claim 1, further comprising:
providing a scene configuration interface that accepts declarative layout data; and
compiling the declarative layout data into the scene graph used by a render pipeline for the reconfigurable modular display.

12. The non-transitory machine-readable storage medium of claim 1, wherein handling audio comprises:
accepting microphone input for public-address functionality;
applying gain control and ducking to lower background audio during announcements; and
aligning audio cues with visual effects at defined trigger points.

13. The non-transitory machine-readable storage medium of claim 1, wherein the local onboarding flow issues signed session tokens to operator devices and records audit logs of role-scoped operations.

14. The non-transitory machine-readable storage medium of claim 1, further comprising:
executing a diagnostic routine that verifies provisioning of the local wireless connectivity;
display of the machine-readable pairing code;
enumeration of display tiles and layout formation;
loopback of the programmatic interface; and
interactive activity latency against acceptance thresholds for end-of-line testing.

15. A method of manufacturing a portable interactive scoreboard assembly comprising:
extruding or procuring an elongated rail that defines an internal conduit;
installing within the internal conduit a power and data interconnect terminated by polarized waterproof multi-pin connectors;
affixing the elongated rail to or within an enclosure;
mechanically attaching a plurality of display tiles to the elongated rail and mating the display tiles to the polarized waterproof multi-pin connectors to form a reconfigurable modular display; and
installing a controller and a power-management circuit within the enclosure and electrically coupling the controller to the power and data interconnect.

16. The method of claim 15, further comprising:
forming a soft-shell variant by cutting fabric panels;
RF welding or seam-sealing the fabric panels to form an enclosure with transparent windows and integrated fence straps;
integrating a stiffener that retains the elongated rail;
routing the power and data interconnect through strain-relieved pass-throughs with potting compound; and
verifying an ingress-protection rating by water-spray testing window seams and pass-throughs.

17. The method of claim 15, further comprising: forming a rigid variant by injection-molding polymer panels with molded-in bosses for captive fasteners and tripod-thread inserts;
installing silicone gaskets at panel joints and a gasketed service door;
sealing the enclosure with gasketed closures that provide an ingress-protection rating;
mounting magnetic attachment plates; sealing cable glands;
coupling a heat spreader to the elongated rail; and
verifying enclosure integrity by pressure-decay testing or leak testing.

18. The method of claim 15, further comprising:
assembling a battery-management printed circuit board by surface-mount soldering a protection and balancing controller and a fuel-gauge device;
performing in-circuit testing; installing power-path components and hold-up capacitors that support hot-swapping of a removable rechargeable battery;
providing a removable rechargeable battery interface;
integrating a charger for a photovoltaic module; and
performing an end-of-line test comprising powering the assembly, establishing locally hosted wireless connectivity, rendering a machine-readable pairing code on the reconfigurable modular display, enumerating the display tiles to form a layout, verifying a programmatic interface loopback, and measuring interactive activity responsiveness within a target latency.

19. A portable interactive scoreboard system comprising:
a reconfigurable modular display including a plurality of display tiles mechanically attachable to a backplane providing a power and data interconnect;
a controller operatively coupled to the reconfigurable modular display and configured to drive scoreboard graphics on the display tiles via the power and data interconnect; and
an interaction engine of the controller configured to present an interactive activity on the reconfigurable modular display and to receive spectator inputs via a local wireless connectivity provided by the controller;
wherein the controller updates the reconfigurable modular display based at least on game-state data received via a programmatic interface and an aggregation of the spectator inputs.

20. The system of claim 19, wherein:
the controller is configured to enumerate the display tiles over the power and data interconnect to determine a layout, recompute the layout responsive to attachment or removal of a display tile, and drive a dual-sided configuration with independent content selections for respective sides;
the system further comprises a local wireless connectivity interface of the controller configured to accept concurrent connections from multiple client devices without reliance on external networking infrastructure; and
the controller comprises an ingestion interface configured to obtain game-state data from at least one external source via the programmatic interface.
